(19) United States
(12) Patent Application Publication
(10) Pub. No.: US 2023/0214579 A1
(43) Pub. Date: Jul. 6, 2023

(54) INTELLIGENT CHARACTER CORRECTION AND SEARCH IN DOCUMENTS

(71) Applicant: MICROSOFT TECHNOLOGY LICENSING, LLC, Redmond, WA (US)

(72) Inventors: Haim Somech, Ramat Gan, IL (US); Adi L. Miller, Ramat Hasharon, IL (US); Ido Priness, Herzliya, IL (US)

(21) Appl. No.: 17/566,980

(22) Filed: Dec. 31, 2021

(51) Int. Cl. G06F 40/166; G06F 16/33; G06F 16/93; G06N 20/00

(52) U.S. Cl. CPC G06F 40/166; G06F 16/3344; G06F 16/93; G06N 20/00

(57) ABSTRACT

Various embodiments discussed herein are directed to improving existing technologies by causing certain characters to be replaced at a document if such characters are likely to be an error. For example, documents generated using speech-to-text technology or Optical Character Recognition (OCR) technology often contain character errors. A scoring threshold may be utilized to determine one or more characters are not being correctly represented in the document. Alternatively or additionally, various embodiments recommend multiple character sequences as candidates to replace other characters and a user may select which of the candidates will be used for replacement.

### INTRODUCTION

A variety of computer-implemented technologies generate or process documents. For example, some speech-to-text technologies encode audio speech data to produce written natural language words in a transcript document. In another example, some Optical Character Recognition (OCR) technologies encode images into machine-readable text. However, these and other technologies often incorrectly encode text characters due to various factors, such as audio noise, model tuning issues, phonetic problems, and visible natural language quality, among others. Further, these and other technologies fail to intelligently correct text characters. Consequently, these and other technologies are inaccurate. Moreover, such inaccuracy leads to computer information retrieval errors, such as being unable to fetch and access certain query search terms issued by a user.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Various embodiments discussed herein are directed to improving existing technologies by causing certain characters (for example, words) to be replaced at a document if such characters are likely to be an error. For example, documents generated using speech-to-text technology or Optical Character Recognition (OCR) technology often contain character errors. A scoring threshold may be utilized to determine certain characters as not being correctly represented (for example, misspelled or misplaced) in the document. Alternatively or additionally, various embodiments recommend multiple character sequences as candidates to replace other characters and a user may select which of the candidates will be used for replacement.

In operation, some embodiments first determine a score for a first set of characters in a document, where the score is indicative of a likelihood that the first set of characters are incorrectly represented in the document. For example, a machine learning model can be trained and fine-tuned to predict whether each word or sentence in the document is incorrectly spelled or incorrectly placed among other words in a document based on Next Sentence Prediction (NSP), Mask Language Modeling (MLM), user information, or the like. Such user information can include email messages, chat messages, meeting transcripts, text messages, or the like.

Some embodiments additionally receive a query request to do a computer search at the document. Responsively, some embodiments determine that a second set of characters are candidates to replace the first set of characters based on the score of the first set of characters, the user information, and/or the query request. For example, a language model may be fine-tuned on email messages, chat messages, or text messages of a user so that particular embodiments can detect whether the document contains incorrect terms and potential replacements for those terms, as found in the user's email messages, chat messages, text messages, or the like. In this way, the user's query can still be executed even though certain query terms may be missing or otherwise incorrectly represented in a document, as described in more detail below.

### BRIEF DESCRIPTION OF THE DRAWINGS

The present invention is described in detail below with reference to the attached drawing figures, wherein:

FIG. 1 is a block diagram illustrates an example operating environment suitable for implementing some embodiments of the disclosure;

FIG. 2 is a block diagram depicting an example computing architecture suitable for implementing some embodiments of the disclosure;

FIG. 3 is a schematic diagram illustrating different models or layers, each of their inputs, and each of their outputs, according to some embodiments;

FIG. 4 is a block diagram of a modified BERT model or encoder that uses particular inputs to predict certain natural language characters, whether they are incorrectly represented, and if they are incorrectly represented, what the predicted correct replacements candidates are, according to some embodiments;

FIG. 5 is a schematic diagram illustrating how a neural network makes particular training and deployment predictions given specific inputs, according to some embodiments;

FIG. 6A is a screenshot of an example user interface for replacing characters in a document with other characters, according to some embodiments;

FIG. 6B is a schematic diagram of a screenshot of a user interface, which illustrates the character sequence of FIG. 6A being replaced with other characters, according to some embodiments;

FIG. 7 is a schematic diagram of a document and corresponding user interface functionality for indicating incorrectly represented characters and replacement candidates, according to some embodiments;

FIG. 8 is a flow diagram of an example process for training a machine learning model using a supervised technique, according to some embodiments;

FIG. 9 is a flow diagram of an example process for determining a set of characters that are candidates to replace other characters of a document, according to some embodiments;

FIG. 10 is a flow diagram of an example process for executing a query request to do a computer search of one or more characters at a document, according to some embodiments; and

FIG. 11 is a block diagram of an example computing device suitable for use in implementing some embodiments described herein.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a stand-alone application, a service or hosted service (stand-alone or in combination with another hosted service), or a plug-in to another product, to name a few.

Existing speech-to-text technologies are inaccurate. In audio recording contexts (for example, a video conferencing meeting), there is often a lot of background noise, such as multiple people talking at the same time. However, encoders have difficulty encoding audio speech to text in this scenario, as they will either encode and combine characters from different speakers or fail to encode text altogether. For example, one speaker might say, “let's start on the project” and another speaker at the same time might say, “who will be responsible for the beginning.” Accordingly, because multiple unrelated words are received in parallel, the encoder may encode the sentence to be “let's who start from the beginning.” Not only does this sentence incorrectly represent what each speaker said, but certain words are missing from each speaker and it may be unclear which words to attribute to which speaker.

Additionally, speech-to-text technologies often experience phonetic issues when users have unique accents or when they say unique words that are not part of a regular natural language base, such as English. Phonetics is a branch of linguistics that focuses on the production and classification of speech sounds. In an illustrative example of phonetic issues, a speaker might say a name, such as “Alfonso” and then the sequence “download the file.” Certain words, such as “download” “the” and “file” may be easily processed because the corresponding sounds (for example, phonemes) easily map to common English words via natural language processing models. However, the encoder may encode the word “Alfonso” to be “Along so” or something similar because Alfonso is not a commonly used English word and the phonetic sounds of these two are nearly identical. This is the case for any unique character combination, such as special project names (for example, project “XT5”) or other code names. Existing encoders have difficulty mapping certain phonetic sounds to specific words.

Additionally, speech-to-text technologies often experience problems in encoding or transcription when there are network hikes or outages. For example, in a video conferencing meeting, a user device typically captures audio data of a user and transmits, in near-real time, streams or packets of the audio data, over a computer network, to a server (for example, a transcription service), which buffers the data and encodes the audio data into text. However, if there is a network outage, even if the user is currently speaking, the user device can no longer send packets of data of the user's real-time speech over the computer network. Consequently, the server never receives that part of the speech, which results in fragmented transcriptions with large speech gaps by users. For example, the transcription document may contain incomplete sentences or incomplete speaker utterances corresponding to the time of a network outage.

Existing machine learning models themselves are also inaccurate. These models are often only trained to understand basic human language. And if they are fine-tuned to perform other tasks, the fine-tuning is generic or static in nature. For example, some models may only be fine-tuned to recognize widely recognized popular names (for example, John), popular phrases, and the like. However, this generic one-size-fits-all approach fails to account for names (for example, Huang), phrases, or other text characters unique to particular users, particular business units, or the like, which are not necessarily widely recognized. For example, a business unit or user may refer to a completion of a project as “CAD” (“complete and done”). Accordingly, speakers in a meeting may refer to a project as being “CAD.” However, existing models are not granularly fine-tuned to recognize what “CAD” means and may instead encode this phrase to a similar English analogue, such as “SAD” or the like.

Existing Optical Character Recognition (OCR) technologies are also inaccurate. Often times a source document, such as a tangible paper (or image of the paper), contains many noise signals, such as smudges, scratches, paper folds, blurred or missing characters, or unreadable text (for example, because a user's handwriting is not recognizable). Accordingly, there are often various errors when these technologies encode characters into machine-readable text due to the noise. In other words, these technologies are unable to accurately predict or determine what the text represents that is being encoded because the text is unrecognizable or too distorted.

Because of these issues with the accuracy of existing speech-to-text, OCR, machine learning models, and other technologies, computers are also deficient in retrieving the proper data. For example, after a PDF document has undergone OCR, a user may issue a query for a certain term that is blurred, scratched, or otherwise unreadable. However, as described above, the encoder is unable to encode the term with any confidence because it is unreadable. Consequently, the search engine is unable to fetch and retrieve the term. In another example, audio speech, where several users have spoken at once, may have been encoded into a tangible transcript of natural language characters. These natural language characters may combine several incoherent fragments based on the users speaking at once. Given the length of the transcript being several pages long, a user may desire to search the transcript where meeting participants spoke about a subject. However, discussion of the subject may have occurred when multiple speakers were speaking at once. As a result, the encoder is unable to encode the audio data into the text (corresponding to the subject) because of the additional noise. Consequently, the search engine is unable to fetch and retrieve the term corresponding to the subject that the searching user is interested in.

Various embodiments of the present disclosure provide one or more technical solutions to these technical problems, as well as other problems, as described herein. Particular embodiments are directed to causing certain characters to be replaced at a document if the certain characters have fallen below a scoring threshold indicative of the characters not being correctly represented in the document. Alternatively or additionally, various embodiments can recommend certain characters as candidates to replace other characters (without necessarily replacing the characters) in a document.

In operation, some embodiments first determine a score for a first set of characters in a document, where the score is indicative of a likelihood that the first set of characters are incorrectly represented in the document. For example, a machine learning model can be trained and fine-tuned to predict whether each word or sentence in the document is incorrectly spelled or incorrectly placed in the document (for example, via Next Sentence Prediction (NSP), Mask Language Modeling (MLM), user information, or the like). Some embodiments access one or more data records (for example, a database row) that include information about one or more users associated with the document. For example, some embodiments call a function that reads a network graph to retrieve a user's email messages, chat messages, text messages, or the like. Some embodiments additionally receive a query request to do a computer search at the document. Responsively, some embodiments determine that a second set of characters are candidates to replace the first set of characters based on the score of the first set of characters, the information about the one or more users, and/or the query request. For example, a language model may be fine-tuned on such email messages, chat messages, or text messages of the user so that particular embodiments can detect whether the document contains incorrect terms and potential replacements for those terms, as found in the user's email messages, chat messages, text messages, or the like. In this way, the user's query can still be executed even though certain query terms may be missing or otherwise incorrectly represented in a document, as described in more detail below.

Various specific implementations described herein provide technical solutions to the technical problems described above by, among other aspects, improving the accuracy of existing speech-to-text technologies. In particular, even if there is a lot of background noise, such as multiple people talking at the same time or other audio noise, particular embodiments are still able to produce a document with correct characters. This is because embodiments can first detect, via a score, that certain characters are incorrectly represented in a document. For example, using the illustration above where multiple seemingly unrelated words are received in parallel, and the encoder encodes the sentence to be “let's who start from the beginning.” Particular embodiments, using NSP, MLM, and/or user information (for example, historical email messages, chat, meeting transcriptions) can detect that this phrase is incorrectly represented, such as detecting that certain words are missing. Additionally, particular embodiments are also able to recommend replacement candidates for the missing words based at least in part on the user information (for example, by fine-tuning a model on user emails, chats, meeting transcripts, and the like). In this way, documents are more likely to reflect correct character sequences and are therefore more accurate relative to existing technologies.

Additionally, particular embodiments provide technical solutions by improving speech-to-text technologies even where the audio speech data includes there are phonetic issues, such as unique accents or unique words/phrases spoken, which may cause errors by the computer. This is because some embodiments use additional signals that existing technologies fail to use, such as user information and/or fine-tuned natural language processing to correct characters. In this way, certain contextual words can be mapped to information outside of the normal natural language understanding context. For example, using the illustration above, if a speaker says the name “Alfonso” and then the sequence “download the file,” particular embodiments are able to locate these words together in external user documents, such as emails. Accordingly, there is a high degree of confidence that the word is “Alfonso” and not some other word because the same sequence of words (or a threshold sequence of the words) were used together in another source. Accordingly, certain words and phrases can be mapped to other words and phrases in the external documents to determine semantic meaning, syntax, spelling, or other correct representation of a document.

Particular embodiments also provide technical solutions by improving speech-to-text technologies even when there are network hikes or outages. This is because some embodiments use additional signals that existing technologies fail to use, such as user information or natural language processing to impute or populate documents with missing or incorrect characters. For example, due to a network outage, if a transcription document contains incomplete sentences or incomplete speaker utterances, particular embodiments are able to fill in the incomplete sentences or incomplete speaker utterances using functionality, such as NSP, MLM (or other natural language processing), or based on external user information. For example, some embodiments can predict that the transcript phrase “report back to me by . . . road map tomorrow” should be inputted with, “report back to me by Friday. Then we can finish the project X road map tomorrow.” Such imputation can be based on a user email that reiterates what was talked about in the meeting, such as when the reporting would take place—i.e., Friday—and what the “road map” corresponds to—i.e., the “project X road map,” which was missing in the transcription due to the network outage.

Particular embodiments also provide technical solutions by improving existing machine learning models. This is because particular model embodiments are not statically trained or fine-tuned. Rather particular embodiments dynamically train or fine-tune models to recognize names (for example, Huang), phrases, or other text characters unique to particular users, particular business units, or the like, which are not necessarily widely recognized. For instance, some embodiments train on specific users' emails, chats, meeting transcripts and the like. For example, using the illustration above, if speakers in a meeting refer to a project as being “CAD,” particular embodiments are granularly fine-tuned to predict that this refers to “complete and done” as indicated in several of the users' emails. This is opposed to existing technologies that would instead map this phrase to a syntactically similar English analogue, such as “SAD” or the like.

Particular embodiments also provide technical solutions by improving the accuracy of existing computer-performed Optical Character Recognition (OCR) technologies. Even if a document contains many noise signals, such as smudges, scratches, paper folds, blurred or missing characters, or unreadable text, particular embodiments are still able to produce a document with complete and accurate machine-readable text. This is because some embodiments are able to use additional signals that existing OCR technologies fail to use to predict which characters are incorrectly represented and predict which characters can replace those characters. For example, some embodiments use user information (for example, user emails, user chats, historical meeting transcripts) and/or natural language processing to identify incorrect characters and then replace the incorrect characters with correct ones, as described in more detail below.

Particular embodiments also provide technical solutions by improving the way computers operate, such as improvement in the retrieval of data. As described above, particular embodiments improve the accuracy of existing speech-to-text, OCR, models, and other technologies such that the correct text characters are represented in a document. As such, computers are also able to search for and fetch any data requested via a query request. For example, using the illustration above, after a PDF document has undergone OCR, a user may desire to search for a certain term that is blurred, scratched, or otherwise unreadable. However, a model may first predict that the text is unreadable or represented incorrectly in the document. The model may then predict that the text corresponds to a particular word based on external user information, where the user has used the particular word several times. As a result, computers are able to search in the document for and retrieve the particular word, which would have been otherwise non-retrievable by computers.

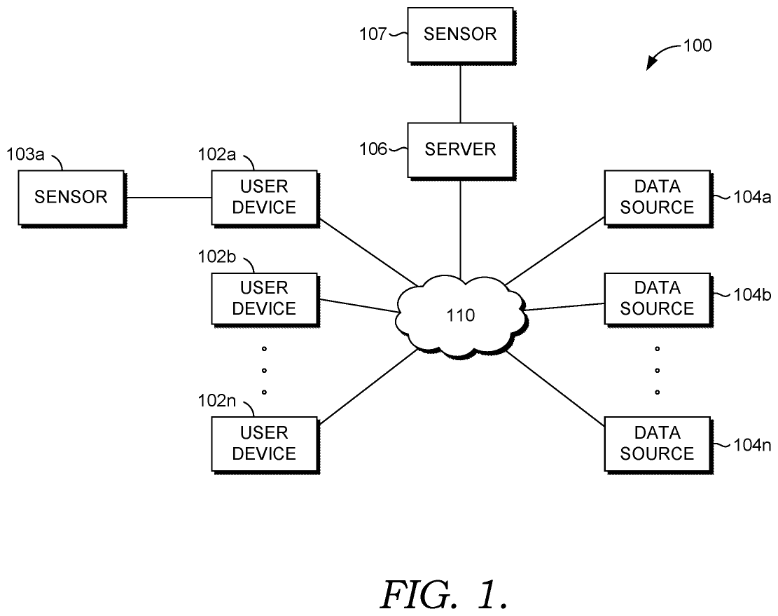

Turning now to FIG. 1, a block diagram is provided showing an example operating environment 100 in which some embodiments of the present disclosure may be employed. It should be understood that this and other arrangements described herein are set forth only as examples. Other arrangements and elements (for example, machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, and/or software. For instance, some functions may be carried out by a processor executing instructions stored in memory.

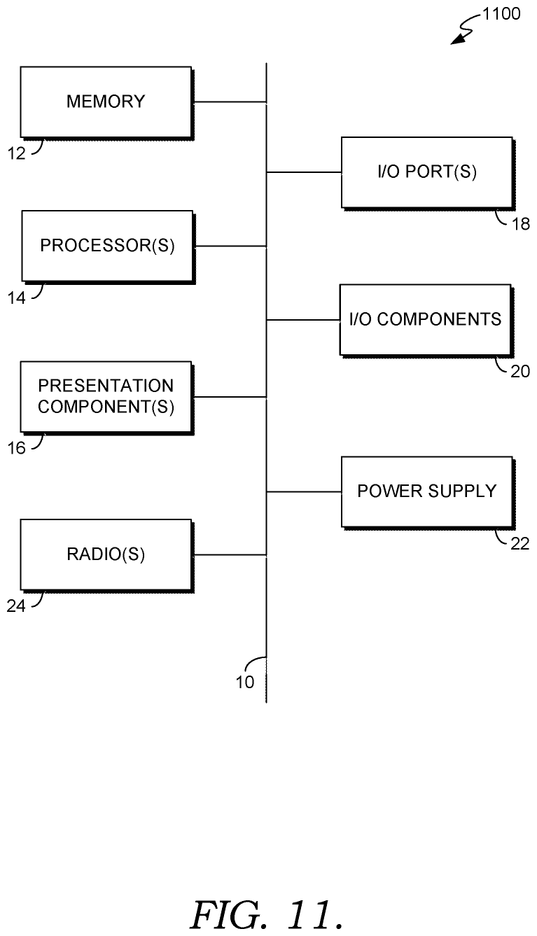

Among other components not shown, example operating environment 100 includes a number of user devices, such as user devices 102a and 102b through 102n; a number of data sources (for example, databases or other data stores), such as data sources 104a and 104b through 104n; server 106; sensors 103a and 107; and network(s) 110. It should be understood that environment 100 shown in FIG. 1 is an example of one suitable operating environment. Each of the components shown in FIG. 1 may be implemented via any type of computing device, such as computing device 1100 as described in connection to FIG. 11, for example. These components may communicate with each other via network(s) 110, which may include, without limitation, a local area network (LAN) and/or a wide area networks (WAN). In some implementations, network(s) 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities. In some embodiments, the one or more servers 106 represent one or more nodes in a cloud computing environment. Consistent with various embodiments, a cloud computing environment includes a network-based, distributed data processing system that provides one or more cloud computing services. Further, a cloud computing environment can include many computers, hundreds or thousands of them or more, disposed within one or more data centers and configured to share resources over the one or more network(s) 110.

In some embodiments, a user device 102a or server 106 alternatively or additionally comprises one or more web servers and/or application servers to facilitate delivering web or online content to browsers installed on a user device 102b. Often the content may include static content and dynamic content. When a client application, such as a web browser, requests a website or web application via a URL or search term, the browser typically contacts a web server to request static content or the basic components of a website or web application (for example, HTML pages, image files, video files, and the like). Application servers typically deliver any dynamic portions of web applications or business logic portions of web applications. Business logic can be described as functionality that manages communication between a user device and a data store (for example, a database). Such functionality can include business rules or workflows (for example, code that indicates conditional if/then statements, while statements, and the like to denote an order of processes).

User devices 102a and 102b through 102n may comprise any type of computing device capable of use by a user. For example, in one embodiment, user devices 102a through 102n may be the type of computing device described in relation to FIG. 11 herein. By way of example and not limitation, a user device may be embodied as a personal computer (PC), a laptop computer, a mobile phone or mobile device, a smartphone, a tablet computer, a smart watch, a wearable computer, a personal digital assistant (PDA), a music player or an MP3 player, a global positioning system (GPS) or device, a video player, a handheld communications device, a gaming device or system, an entertainment system, a vehicle computer system, an embedded system controller, a camera, a remote control, a bar code scanner, a computerized measuring device, an appliance, a consumer electronic device, a workstation, or any combination of these delineated devices, or any other suitable computer device.

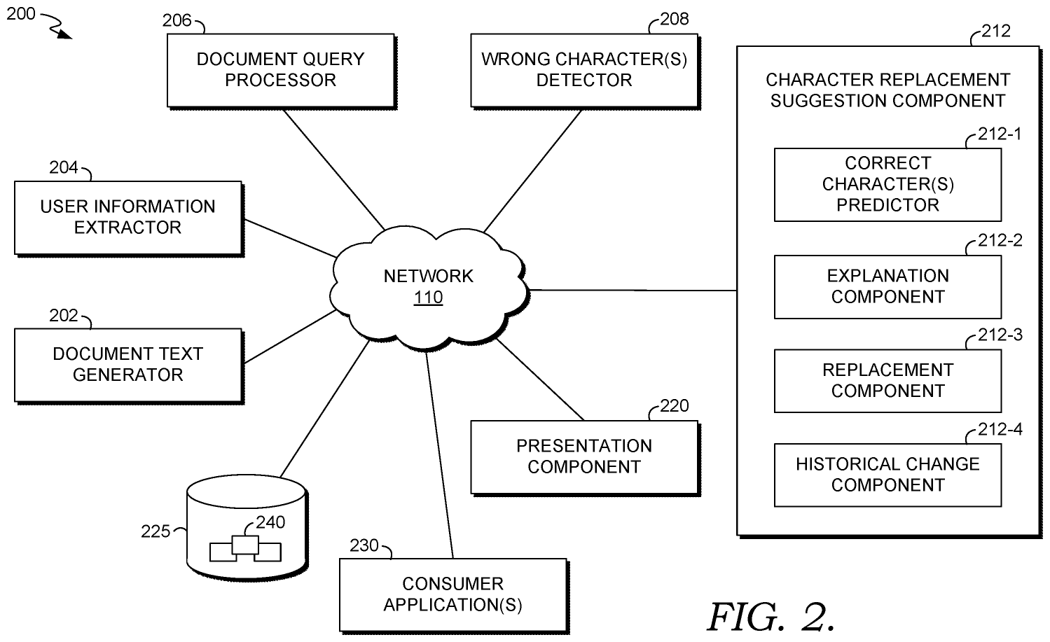

Data sources 104a and 104b through 104n may comprise data sources and/or data systems, which are configured to make data available to any of the various constituents of operating environment 100 or system 200 described in connection to FIG. 2. Examples of data source(s) 104a through 104n may be one or more of a database, a file, data structure, corpus, or other data store. Data sources 104a and 104b through 104n may be discrete from user devices 102a and 102b through 102n and server 106 or may be incorporated and/or integrated into at least one of those components. In one embodiment, data sources 104a through 104n comprise sensors (such as sensors 103a and 107), which may be integrated into or associated with the user device(s) 102a, 102b, or 102n or server 106.

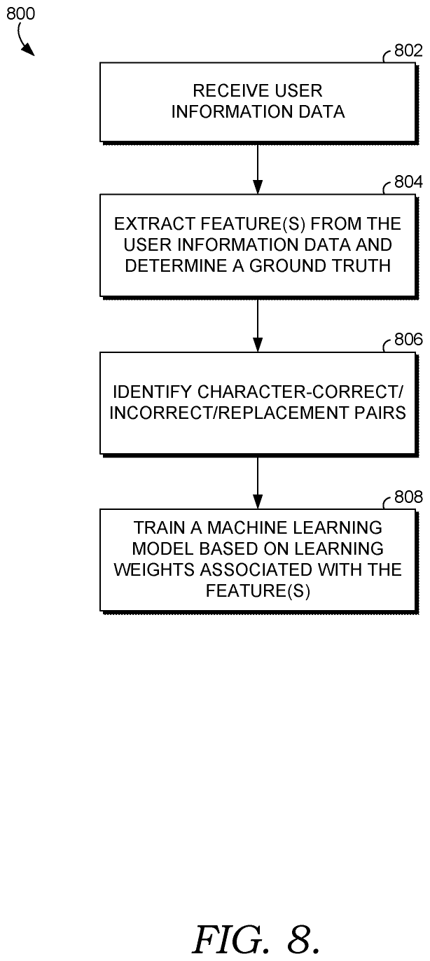

Operating environment 100 can be utilized to implement one or more of the components of the system 200, described in FIG. 2, including components for determining characters that are candidates to replace other characters in a document, as described herein. Operating environment 100 also can be utilized for implementing aspects of processes 800, 900, and/or 1000 described in conjunction with FIGS. 8, 9, 10, and any other functionality as described in connection with FIGS. 2-11.

Referring now to FIG. 2, in conjunction with FIG. 1, a block diagram is provided showing aspects of an example computing system architecture suitable for implementing an embodiment of the disclosure and designated generally as the system 200. Generally, embodiments of system 200 are generally responsible for causing replacement of certain characters that are incorrectly represented in a document with other characters. System 200 is not intended to be limiting and represents only one example of a suitable computing system architecture. Other arrangements and elements can be used in addition to or instead of those shown, and some elements may be omitted altogether for the sake of clarity. Further, as with operating environment 100 of FIG. 1, many of the elements described herein are functional entities that may be implemented as discrete or distributed components or in conjunction with other components, and in any suitable combination and location. For instance, the functionality of system 200 may be provided via a software as a service (SAAS) model, for example, a cloud and/or web-based service. In other embodiments, the functionalities of system 200 may be implemented via a client/server architecture.

The system 200 includes a document text generator 202, a user information extractor 204, a document query processor 206, a wrong character(s) detector 208, a character replacement suggestion component 212, a presentation component 220, one or more consumer applications 230, and one or more data stores, such as storage 225, each of which are communicatively coupled via one or more computer networks 110.

The document text generator 202 is generally responsible for generating a document (for example, a transcript of audio data) or processing a document so that it is machine-readable. For example, in some embodiments the document text generator 202 uses OCR to convert or encode an image (for example, a JPG image file of a handwritten message) into machine-readable text. Put differently, a processor executing the document text generator 202 can detect natural language characters and convert such characters into a machine-readable format (for example, so that it can be processed via a machine learning model).

In an illustrative example, a processor executing the document text generator 202 can perform image quality functionality to change the appearance of the document by converting a color document to greyscale, performing desaturation (removing color), changing brightness, and changing contrast for contrast correctness, and the like. Responsively, the processor can perform a computer process of rotating the document image to a uniform orientation, which is referred to as “deskewing” the image. Source documents may be slightly rotated or flipped in either vertical or horizontal planes and in various degrees, such as 45, 90, and the like. Accordingly, some embodiments deskew the image to change the orientation of the image for uniform orientation (for example, a straight-edged profile or landscape orientation). In some embodiments, in response to the deskew operation, some embodiments remove background noise (for example, via Gaussian and/or Fourier transformation). In many instances, when a document is uploaded, such as through scanning or taking a picture from a camera, it is common for resulting images to contain unnecessary dots or other marks due to the malfunction of printers. In order to be isolated from the distractions of this meaningless noise, some embodiments clean the images by removing these marks.

In response to the removing the background noise, some embodiments extract the characters (for example, via pattern recognition or feature detection such as intelligent character recognition (ICR)) from the document image and place the extracted characters in another format, such as JSON. In some embodiments, ICR functionality uses particular rules to detect features. For example, where there two angled lines meet at the top, and where there is a horizontal line between the two lines, then predict to be a letter A. Instead of recognizing complete pattern of an A (as in feature detection), these embodiments detect individual component features (for example, angled lines, crossed lines, etc.) from which a character is made. Formats, such as JSON, can be used as input for other machine learning models, such as Convolutional Neural Networks (CNN) or modified BERT models for language predictions, as described in more detail below. Formats, such as JSON, are also searchable by users so they can perform query requests for characters in the document, as described in more detail below.

In some embodiments, the document text generator 202 alternatively or additionally performs speech-to-text functionality. For example, some embodiments receive an indication that a user has selected a microphone button at a user device to activate the microphone to capture audio data. In response to microphone activation and receiving audio data, a user device may transmit, over a computer network, the audio data in bits to a speech recognition service (to predict what natural language the audio data corresponds to) and/or a voice recognition service (to predict who is speaking), which buffers the data (for example, in a queue data structure). In some embodiments, these services analyze the speech data by parsing the speech data into recognizable components called phonemes. Some models, such as Recurrent Neural Networks (for example, LSTMs) and/or Gaussian Mixture Models (GMM), are used to analyze the speech data based on the order, combination, frequency values, and context of these phonemes in order to predict exactly what a speaking user is saying or what user is speaking.

In an illustrative example, the document text generator 202 breaks down the audio of a speech recording into individual sounds, analyzes each sound, using algorithms (for example, GMM or HMM) to find the most probable word fit in that language, and transcribes those sounds into text. In some embodiments, the document text generator 202 uses Natural Language Processing (NLP) models (for example, GPT-3, BERT, XLNET, or other NLP model) and/or deep learning neural networks to perform its functionality. This means that the speech-to-conversion module 216 breaks the speech down into bits it can interpret, converts it into a digital format, and analyzes the pieces of content.

Some embodiments additionally or alternatively use NLP modules to determine the context and syntax of an audio segment to figure out the best match for the words speakers speak. These and other models map the analyzed speech data with the written text that best matches the speech data by comparing text candidates with audio segments. Based on the best match, particular embodiments produce an output transcript or document of written natural language that indicates or corresponds to the audio data that was spoken.

Continuing with FIG. 2, the user information extractor 204 is generally responsible for extracting data or information associated with one or more users. For example, in some embodiments, the user information extractor 204 communicates, over the network(s) 110, with an email server and/or a chat server and requests messages transmitted by or received by a user. Such servers may include a specialized Application Programming Interface (API) in order to retrieve the corresponding data, which is then transmitted back over the network(s) 110 to a host that includes the user information extractor 204. Alternatively or additionally, all such user information may be centrally located in a user profile 240 and/or a data store such as storage 225, and the data from each server may be represented in corresponding data records (or other data structures, such as network graphs) that can be queried and extracted by the user information extractor 204. Alternatively or additionally, the user information extractor 204 performs data scraping or crawling of multiple web pages (or app pages) for various sessions and extracts information, such as UI selections, emails sent, chat messages sent, and the like.

In some embodiments, the user information extractor 204 is additionally or alternatively generally responsible for accessing or receiving (and in some cases also identifying) user data from one or more data sources, such as data sources 104a and 104b through 104n of FIG. 1. In some embodiments, user information extractor 204 may be employed to facilitate the accumulation of user data of a particular user (or in some cases, a plurality of users including crowdsourced data). The data may be received (or accessed), and optionally accumulated, reformatted, and/or combined, by the user information extractor 204 and stored in one or more data stores such as storage 225, where it may be available to other components of system 200. For example, the user data may be stored in or associated with a user profile 240, as described herein. In some embodiments, any personally identifying data (for example, user data that specifically identifies particular users) is either not uploaded or otherwise provided from the one or more data sources with user data, is not permanently stored, and/or is not made available to the components or subcomponents of system 200. In some embodiments, a user may opt into or out of services provided by the technologies described herein and/or select which user data and/or which sources of user data are to be utilized by these technologies.

User data may be accessed via the user information extractor 204 from a variety of sources where the data may be available in a variety of formats. For example, in some embodiments, user data may be determined via one or more sensors, which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both. By way of example and not limitation, user data may include data that is sensed or determined from one or more sensors (referred to herein as sensor data), such as location information of mobile device(s), properties or characteristics of the user device(s) (such as device state, charging data, date/time, or other information derived from a user device such as a mobile device), user-activity information (for example: app usage; online activity; searches; voice data such as automatic speech recognition; activity logs; communications data including calls, texts, instant messages, and emails; website posts; other user data associated with communication events) including, in some embodiments, user activity that occurs over more than one user device, user history, session logs, application data, contacts data, calendar and schedule data, notification data, social-network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personal assistant application or service), home-sensor data, appliance data, GPS data, vehicle signal data, traffic data, weather data (including forecasts), wearable device data, other user device data (which may include device settings, profiles, network-related information (for example, network name or ID, domain information, workgroup information, connection data, Wi-Fi network data, or configuration data, data regarding the model number, firmware, or equipment, device pairings, such as where a user has a mobile phone paired with a Bluetooth headset, for example, or other network-related information)), gyroscope data, accelerometer data, payment or credit card usage data (which may include information from a user's PayPal account), purchase history data (such as information from a user's Xbox Live, Amazon.com, or eBay account), other sensor data that may be sensed or otherwise detected by a sensor (or other detector) component(s) including data derived from a sensor component associated with the user (including location, motion, orientation, position, user-access, user-activity, network-access, user-device-charging, or other data that is capable of being provided by one or more sensor components), data derived based on other data (for example, location data that can be derived from Wi-Fi, Cellular network, or IP address data), and nearly any other source of data that may be sensed or determined as described herein.

User data can be received by the user information extractor 204 from one or more sensors and/or computing devices associated with a user. While it is contemplated that the user data may be processed, for example by the sensors or other components not shown, for interpretability by the user information extractor 204, embodiments described herein do not limit the user data to processed data and may include raw data. In some embodiments, the user information extractor 204 or other components of system 200 may determine interpretive data from received user data. Interpretive data corresponds to data utilized by the components of system 200 to interpret user data. For example, interpretive data can be used to provide context to user data, which can support determinations or inferences made by the components or subcomponents of system 200, such as venue information from a location, a text corpus from user speech (for example, speech-to-text), or aspects of spoken language understanding. Moreover, it is contemplated that for some embodiments, the components or subcomponents of system 200 may use user data and/or user data in combination with interpretive data for carrying out the objectives of the subcomponents described herein.

In some respects, user data may be provided in user-data streams or signals. A “user signal” or “signal” can be a feed or stream of user data from a corresponding data source (for example, a particular email service). For instance, a user signal could be natural language text derived from a smartphone, a home-sensor device, a smart speaker, a GPS device (for example, for location coordinates), a vehicle-sensor device, a wearable device, a user device, a gyroscope sensor, an accelerometer sensor, a calendar service, an email account, a credit card account, or other data source. In some embodiments, the user information extractor 204 receives or accesses user-related data continuously, periodically, as it becomes available, or as needed.

Continuing with the user information extractor 204 of FIG. 2, in some embodiments, the data extracted by the user information extractor 204 is sensor data and/or user device data of one or more users and/or contextual information from a meeting invite and/or email or other device activity of users at the meeting.

In some embodiments, the user information extractor 204 monitors user activity via one or more sensors, (for example, microphones, video), devices, chats, presented content, and the like. In some embodiments, the user information extractor 204 monitors user activity information from multiple user devices associated with the user and/or from cloud-based services associated with the user (such as email, calendars, social media, or similar information sources), and which may include contextual information associated with transcripts or content of a meeting. For example, an email may detail conversations between two participants that provide context to a meeting transcript by describing details of the meeting, such as purpose of the meeting. The user information extractor 204 may determine current or near-real-time user activity information and may also determine historical user activity information, in some embodiments, which may be determined based on gathering observations of user activity over time and/or accessing user logs of past activity (such as browsing history, for example). Further, in some embodiments, the user information extractor 204 may determine user activity (which may include historical activity) from other similar users (for example, crowdsourcing).

In some embodiments, the user information extractor 204 monitors user data associated with the user devices and other related information on a user device, across multiple computing devices (for example, associated with all participants in a meeting), or in the cloud. Information about the user's devices may be determined from the user data made available. In some implementations of the user information extractor 204, a user device may be identified by detecting and analyzing characteristics of the user device, such as device hardware, software such as OS, network-related characteristics, user accounts accessed via the device, and similar characteristics, as described above. For example, information about a user device may be determined using functionality of many operating systems to provide information about the hardware, OS version, network connection information, installed application, or the like. Similarly, some embodiments of the user information extractor 204 may determine a device name or identification (device ID) for each device associated with a user.

Continuing with the user information extractor 204, using contextual information related to user devices, a user device may be identified by by detecting and analyzing characteristics of the user device, such as device hardware, software such as OS, network-related characteristics, user accounts accessed via the device, and similar characteristics. For example, as described previously, information about a user device may be determined using functionality of many operating systems to provide information about the hardware, OS version, network connection information, installed application, or the like. In some embodiments, a device name or identification (device ID) may be determined for each device associated with a user. This information about the identified user devices associated with a user may be stored in a user profile associated with the user, such as in user profile 240. In an embodiment, the user devices may be polled, interrogated, or otherwise analyzed to determine contextual information about or signals from the devices. This information may be used for determining a label or identification of the device (for example, a device ID) so that user activity on one user device may be recognized and distinguished from user activity on another user device. Further, as described previously, in some embodiments, users may declare or register a user device, such as by logging into an account via the device, installing an application on the device, connecting to an online service that interrogates the device, or otherwise providing information about the device to an application or service. In some embodiments, devices that sign into an account associated with the user, such as a Microsoft® account or Net Passport, email account, social network, or the like, are identified and determined to be associated with the user.

The document query processor 206 is generally responsible for executing a query request to locate one or more characters in a document. For example, in response to receiving an indication that a user has input a word in a search field, the document query processor 206 engages in a computer read of the document produced by the document text generator 202 to search for and fetch the word (or semantically similar terms) located in the query. The document query processor 206 can additionally rank search results, such as rank characters that are candidates to replace other characters according to the predictions described with respect to the character replacement suggestion component 212.

The document query processor 206 can perform its functionality according to any suitable algorithm and based on any suitable factors. For example, in some embodiments, the document query processor 206 uses term frequency-inverse document frequency (TF-IDF) algorithms. TF-IDF algorithms include numerical statistics that infer how important a query word or term is to a data set. “Term frequency” illustrates how frequently a term of a query occurs within a data set (for example, a digital document), which is then divided by the data set length (i.e., the total quantity of terms in the data set). “Inverse document frequency” infers how important a term is by reducing the weights of frequently used or generic terms, such as “the” and “of,” which may have a high count in a data set but have little importance for relevancy of a query. Accordingly, a query may include the terms “The different models of product X.” These technologies may then rank a data set the highest because it includes the words “product X” with the highest frequency compared to other data sets.

Alternatively or additionally, the query processor 206 uses corpus expansion (also referred to as “document expansion”). Corpus expansion is the process of finding, in a given corpus or document, the complete set of entities that belong to the same semantic class of one or more seed entities (for example, terms of a query), even though those entities may not directly be located in a document. Word mismatch is a common problem in information retrieval. Most retrieval systems match documents and queries on a syntactic level (for example, TF-IDF), that is, the underlying assumption is that relevant documents contain exactly those terms that a user chooses for the query. However, a relevant document might not contain the query words as given by the user (for example, because of the inaccuracy reasons described above with respect to existing technologies). For example, given the input query request (i.e., the “seed set”) {Massachusetts, Virginia, Washington}, a set expansion method may be expected to output all other states in the United States (for example, because of historic user documents considered by the expansion method, such as past user emails), even though the other states are not directly located the document. Some embodiments alternatively or additionally locate semantically related terms to a query based on user word embedding models, such as WORD2VEC, or GloVE.

Continuing with the document query processor 206, in some embodiments, the output produced by such corpus expansion functionality corresponds to what is predicted or determined by the character replacement suggestion component 212, which is described in more detail below. In some embodiments, the document query processor 206 performs its functionality based on the incorrect characters determined by the wrong character(s) determiner 208, as described in more detail below.

Some embodiments of the document query processor 206 use corpus expansion, as opposed to query expansion (QE) for computational reasons. A disadvantage of QE is the inherent inefficiency of reformulating a query. After QE ranks different documents or characters, the query has to be re-run, which decreases throughput and network latency but requires the re-processing of inverted lists for the original query terms. Further, new lists have to be retrieved, decoded, and analyzed. Conversely, the queries in document expansion do not have to be re-run because the queries are not appended to, thereby increasing throughput and improving network latency.

The wrong character(s) detector 208 is generally responsible for determining (for example, generating or receiving) a score for one or more characters in a document. In some embodiments such score is indicative of a likelihood that the one or more characters are incorrectly represented in a document. For example, the wrong character(s) detector 208 may score each word or sentence (for example, via NSP or MLM) in a document indicative of the probability of the word or sentence being correct (or incorrect), and the associated confidence level (for example, 30% likelihood that the word is correctly represented in the document). In some embodiments, to be “incorrectly represented in a document” means the one or more character sequences (for example, words) are: incorrectly/correctly spelled, incorrectly/correctly formatted, incorrectly/correctly placed in the document (for example, words or sentences are incorrectly ordered), present when they should not be present (needs to be deleted), not present when they should be present (are missing), or the like. In some embodiments, a set of characters can be incorrectly represented in a document even though they are, for example, spelled and formatted correctly because user information indicates that the set of characters should be a different set of characters. For example, a sentence may read “the project is on time” and a language model may validate that this is a correct sentence. However, based on a user query of the term “onti” and user emails that repeatedly refer to the project name of “onti,” particular embodiments may flag the words “on time” as being incorrectly represented and correct these words with the character sequence “onti.”

In some embodiments, the wrong character(s) detector 208 uses syntactic and/or semantic analysis to determine the likelihood of incorrect representation (for example, incorrect spelling or word order). For example, in some embodiments, the wrong character(s) detector 208 uses Natural Language Processing (NLP) techniques to detect the likelihood of incorrect characters. NLP determines semantic relationships among different words, which includes determining what words have a same or similar (for example, within a threshold distance when the words represent vectors) meaning, even if they are syntactically different. This is to say, semantic similarity between words on a document page can be determined even if they are syntactically different. “Syntax” or syntactic properties refers to the structure of character sequences of the content (as opposed to the semantics or meaning), such as the structure of a sentence. For example, “car” and “far” are syntactically similar but have two different definitions so they are not semantically similar. Rather, “far” and “distant” are semantically similar because they mean the same thing, even though they are structurally or syntactically different.

In some embodiments, the wrong character(s) detector 208 uses NLP by tokenizing characters in a document into their constituent words, numbers, symbols, and some or each of the words are tagged with a part-of-speech (POS) identifier. “Tokenization” or parsing in various embodiments corresponds to a computer-implemented process that segments the content into words, sentences, symbols, character sequence, and/or other elements of the content. This can include a set of rules for analyzing a message, such as word and/or part of speech (POS) order. For example, for the sentence “the girl jumped happily”, the syntax may correspond to a word order where the structure is subject-verb-adverb (or subject, verb, object, etc.). In various embodiments, each word of a page is tagged with identifiers, such POS identifiers.

In some embodiments, NLP derives semantic and syntactic content of semi-structured or unstructured data (for example, data in image files). This is in contrast to analyzing “structured” data, such as data in a database. NLP can be configured to parse content to determine semantic context (for example, the meaning of words by analyzing each word in a page against each other and against training data) and syntax context (for example, the set of rules that govern structure of sentences in a given language). NLP is configured to recognize keywords, contextual information, and metadata tags associated with one or more portions of a set of data. In certain embodiments, NLP analyzes summary information, keywords, text descriptions included in the set of data, and uses syntactic and semantic elements present in this information to identify the interest contexts. The syntactic and semantic elements can include information such as word frequency, word meanings, text font, italics, hyperlinks, proper names, noun phrases, parts-of-speech (for example, noun, adverb, adjective, and the like) and/or the context of surrounding words. Other syntactic and semantic elements are also possible.

In some embodiments, the wrong character(s) detector 208 additionally or alternatively uses other NLP-based functionality, such as Named Entity Recognition (NER). NER is an information extraction technique that identifies and classifies elements or “entities” in natural language text into predefined categories. Such predefined categories may be indicated in corresponding tags or labels. Entities can be, for example, names of people, specific organizations, specific locations, specific times, specific quantities, specific monetary price values, specific percentages, specific pages, and the like. Likewise, the corresponding tags or labels can be specific people, organizations, location, time, price (or other invoice data) and the like. In this context of the present disclosure, for example, these tags or labels can indicate whether certain extracted characters (for example, “XJ5”) corresponds to a particular project name, the name of a person, or the like.

In some embodiments, the wrong character(s) detector 208 additionally or alternatively uses one or more natural language processing machine learning models, such as Bidirectional Encoder Representations from Transformers (BERT), WORD2VEC models, GloVe models, autoencoders, or transformers. An “autoencoder” is a neural network that operates by taking in data, compressing and encoding the data, and then reconstructing (decoding) the data from the encoding representation. The model is trained until the loss is minimized and the data is reproduced as closely as possible. Through this process, an autoencoder can learn the important features of the data. A “transformer” is a deep learning model that adopts the mechanism of attention, differentially weighting the significance of each part of the input data. Unlike Recurrent Neural Networks (RNN), transformers do not necessarily process the data in order. Rather, the attention mechanism provides context for any position in the input sequence. For example, if the input data is a natural language sentence, the transformer does not need to process the beginning of the sentence before the end. Rather, it identifies the context that confers meaning to each word in the sentence. This feature allows for more parallelization than RNNs and therefore reduces training times. NLP models, such as transformers, as they relate to particular embodiments are described in more detail below.

Continuing with the wrong character detector 208, alternative or in addition to using NLP as described above, in some embodiments, the wrong character(s) detector 208 determines the likelihood of incorrect representation based on user information extracted by the user information extractor 204. In other words, the score is based at least in part on information outside of the document and is rather based on historical data associated with one or more users. For example, some embodiments evaluate or read a “context” of one or more characters sequences in a document. A “context” refers to a threshold (for example, a predetermined threshold) quantity of characters before and/or after a particular character sequence. Responsively, the wrong character(s) detector 208 can programmatically call the user information extractor 204 so that the user information extractor 204 can scan data sources (for example, user emails, user chats, or other documents written by the user) for the same or similar contexts. In some embodiments, if the contexts from the document and external user sources are within a threshold similarity (for example, within a particular Euclidean distance), the context (or words in the context) are represented correctly (or are scored higher for being represented correctly. For example, if a document says “we'll add more data to project TXL5” and the same or similar characters were located in user emails, chats, and the like, then the probability that this character sequence is incorrect is low (or probability of being correct is high). Some embodiments use NSP and/or MLM to determine whether particular characters are correctly represented, where characters sequences represented in the user information (extracted by the user information extractor 204) represents the ground truth. NSP and MLM are described in more detail below.

Alternatively or additionally, in some embodiments the wrong character(s) detector 208 determines the likelihood of incorrect representation based on one or more terms a user has input in a query (that is processed via the document query processor). For example, in response to detecting that the user has input a query, the document query processor 206 may first determine that there is no syntactic or keyword match between the query and the document, which is a first signal or indication that the query is incorrectly represented in the document somehow. Responsively, in some embodiments, the document query processor 206 programmatically calls the user information extractor 204 so that it can search user information for the query (for example, character sequence) the user issued (for example, find an exact syntactic match). In some embodiments, if there is a match between the query and some character sequence in the user data, then the user information extractor 204 returns the characters sequence representing the query as well as additional context (for example, surrounding words of the same document) to the wrong character(s) detector 208. Responsively, in some embodiments, the wrong character(s) detector 208 syntactically or semantically matches such context to corresponding context in the document (i.e., the document that the user has issued a search query at).

This gives the wrong character(s) an indication of what character(s) in the document may be incorrectly represented (for example, so that it can show the user, which words, and where in the document, are incorrect). For example, a user's email may say something like “send me the results of project XT5 for our annual budget meeting.” And a transcribed document may say “are you done with the results of the hex E5 project for our annual budget meeting.” A user may issue a query of “XT5” but since the encoding functionality encoded this as “hex E5” there is no corresponding term found in the document. However, because there is a word match over a threshold—for example, a match between “project,” “results” and “annual budget meeting,” between the context of this user information source and certain context of the document, particular embodiments can indicate that the word “hex E5” is incorrect (and should be replaced, via the character replacement suggestion component 212, with XT5).

Continuing discussion with the wrong character(s) detector 208, Some embodiments do even more granular processing to find the exact characters that are incorrectly represented to the user (for example, so that they can be highlighted and rendered to a user). For example, in response to determining that there are similar contexts between the document and user information sources, as described above, some embodiments then engage in Jaccard Index or other character matching functionality to determine the similarity between individual characters in each context. And if there is a match over a threshold, then the corresponding word in the document is deemed to be incorrectly represented. For example, using the illustration above, each letter of the query “Hext5” is compared with each letter in each word of the context “are you done with the results of the hex E5 project for our annual budget meeting.” The character sequence with the highest overlap or union (Jaccard Index) is “hex E5.” Therefore, it is determined that this character sequence is incorrectly represented in a document. Alternatively or additionally, reverse transcription or text-to-speech (convert documents into audio data) can be performed so that phonemes or other audio units of each contexts can be compared. If certain audio sounds match over some threshold, then the incorrect representation can be identified. For example, using the illustration above, “XT5” may have a nearly identical phonetic or phoneme sequence as “hex E5.” Accordingly, “hex E5” may be deemed to be incorrectly represented in the document.

Continuing with FIG. 2, the character replacement suggestion component 212 is generally responsible for recommending replacing one or more characters in the document (for example, produced by the document text generator 202) and actually causing such replacement. The character replacement suggestion component 212 includes the corrector character(s) predictor 212-1, the explanation component 212-2, the replacement component 212-3, and the historical change component 212-4.

The correct character(s) predictor 212-1 is generally responsible for determining (for example, predicting) that a set of characters (for example, words) are candidates to replace another set of words in the document. In some embodiments, such determination is based on user information (as detected by the user information extractor 204), one or more terms in a query (as processed by the document query processor 206), and/or determinations mad by the wrong character(s) detector 208. For example, using the illustration above, the wrong character(s) detector 208 may score each word or sentence (for example, via NSP or MLM) in a document indicative of the probability of the word or sentence being correct (or incorrect), and the associated confidence level (for example, 30% likelihood that the word is correctly represented in the document). If the score is below a threshold, embodiments then choose the sentence (for example, via NSP) or word (for example, via MLM) that the model predicts should be present in the document (for example, based on the context found in a user's email as extracted by the user information extractor 204).

In some embodiments, the correct character(s) predictor 212-1 uses syntactic and/or semantic analysis to determine the candidates for replacement (for example, correct spelling or word order), as described above with respect to the wrong character(s) detector 208. For example, in some embodiments, the correct character(s) predictor 212-1 uses the NLP and NER techniques, as described with respect to the wrong character(s) detector 208. For example, in this context of NER, embodiments can indicate whether certain extracted characters (for example, “XJ5”) corresponds to a particular project name, the name of a person, or the like, as found in user information data and recommend that as a candidate to replace another term in a document. In some embodiments, the character replacement suggestion component 212 additionally or alternatively uses one or more natural language processing machine learning models, such as Bidirectional Encoder Representations from Transformers (BERT), WORD2VEC models, GloVe models, autoencoders, or transformers, as described in more detail below.

Continuing with the correct character(s) predictor 212-1, alternative or in addition to using NLP as described above, this component performs its functionality based on one or more terms a user has input in a query (that is processed via the document query processor 206) and/or information obtained by the user information extractor 204. For example, using the illustration above, in response to detecting that the user has input a query, the document query processor 206 may first determine that there is no syntactic or keyword match between the query and the document, which is a first signal or indication that the query is incorrectly represented in the document somehow. Responsively, in some embodiments, the document query processor 206 programmatically calls the user information extractor 204 so that it can search user information for the query (for example, character sequence) the user issued (for example, find an exact syntactic match). In some embodiments, if there is a match between the query and some character sequence in the user data, then the user information extractor 204 returns the characters sequence representing the query back to the correct character(s) predictor 212-1, which then determines that this is character sequence is a candidate to replace other words in a document. In some embodiments, the user information extractor 204 provides additional context (for example, surrounding words of the same document) to the wrong character(s) detector 208. Responsively, in some embodiments, the wrong character(s) detector 208 syntactically or semantically matches such context to corresponding context in the document (i.e., the document that the user has issued a search query at).

This gives the wrong character(s) detector 208 an indication of what character(s) in the document may be incorrectly represented (for example, so that it can show the user, which words, and where in the document, are incorrect) and gives the replacement component 212-3 an indication of where the replacement will actually occur. For example, as described above, because there is a word match over a threshold—for example, a match between “project,” “results” and “annual budget meeting,” between the context of this user information source and certain context of the document, particular embodiments can indicate that the word “hex E5” is incorrect and should be replaced, via the correct character(s) predictor 212-1 with XT5.

Some embodiments use finer granularity for replacement, such as using the Jaccard Index. For example, using the illustration above, each letter of the query (or any character sequence of user information) “Hext5” is compared with each letter in each word of the context “are you done with the results of the hex E5 project for our annual budget meeting.” The character sequence with the highest overlap or union (Jaccard Index) is “hex E5.” Therefore, it is determined that this character sequence is incorrectly represented in a document. And responsively, it is recommended that “hex E5” be replaced with “Hext5.” Alternatively or additionally, as described above, reverse transcription or text-to-speech (convert documents into audio data) can be performed so that phonemes or other audio units of each contexts can be compared. If certain audio sounds match over some threshold, then replacement candidates can be identified. For example, using the illustration above, “XT5” may have a nearly identical phonetic or phoneme sequence as “hex E5.” Accordingly, “hex E5” may be deemed to be incorrectly represented in the document. And “XT5” may be responsively determined to be the candidate to replace “hex E5.”

In some embodiments, the predictions made by the correct character(s) predictor 212-1 (or any replacements made by the replacement component 212-3) is caused to be presented via the document query processor 206 and presentation component 220. For example, using a document expansion algorithm, the document query processor 206 may supplement an original document (or other UI element) with the characters representing candidates to replace other characters.

The explanation component 212-2 is generally responsible for generating and causing display, to a user device, an explanation for why certain characters are candidates to replace other characters in a document (i.e., determinations made by the correct character(s) predictor 212). In some embodiments, such explanation includes natural language explanations. For example, using the illustration above, the explanation component 212-2 may generate a sentence that says “XT5 is recommended as a replacement for ‘hex E5’ in the document because ‘XT5’ was located in several of your emails and ‘hex E5’ is surrounded by similar context as the context XT5 in these emails.” Additionally or alternatively, the explanation can include links, images, or other indicators that indicate, to users, how the correct character(s) predictor 212 made its predictions. For example, using the illustration above, the explanation component 212-2 may embed hyperlinks to the document (or window located at a same page as the document), where the hyperlinks cause the corresponding emails to be surfaced that contain the term “XT5.” In this way, users get a good sense of how the models are making these predictions and whether or not they are correct.

The replacement component 212-3 is generally responsible for the actual replacement of characters with one or more other candidate characters determined by the correct character(s) predictor 212-1. In some embodiments, the replacement component 212-3 (and/or the document query processor 206) ranks each candidate determined by the correct character(s) predictor 212-1. In some embodiments, such ranking is based on a score indicative of a measure of how optimal or suitable one or more characters are suitable for replacing other characters. For instance, the higher the score, the more suitable a candidate is for replacement (for example, the more likely it is to reflect the ground truth or correct character(s)). Such ranking can be based on any suitable factors or weights. For example, using the illustration above, the recommendation that “hex E5” be replaced with “XT5” (or other character sequences) may be a highest ranked or most suitable candidate for replacement based on having the highest letter (for example, using Jaccard Index), word, sentence, and/or phenome matches between the contexts (for example, parts of the document and parts of other external user information sources). And the next highest ranked candidate may have the second most letter and/or phenome matches and so forth. In another example, predictions made based on NLP alone, such as training (and not fine-tuning) a language model (for example, via MLM and NSP) may be ranked lower and predictions additionally or alternatively made using information extracted by the user information extractor 204 are ranked higher. Alternatively or additionally, predictions made using the characters of a query (executed by the document query processor 206) are ranked the highest. For example, if embodiments determine that a query matches some term extracted by the user information extractor 204, this may be ranked highest, whereas if a NLP model merely predicts that some term should replace another term based on language understanding alone, this may be ranked lower.

In some embodiments, the replacement component 212-3 automatically replaces one or more characters without any user input. For example, using the illustration above, in response to the replacement component 212-3 ranking the characters “XT5” as the highest candidate to replace “hex E5,” particular embodiments automatically cause an automatic replacement, in a document, of “hex E5” with “XT5.” Alternatively, in some embodiments, the replacement component replaces one or more characters based on user input. For example, using the illustration above, the correct character(s) predictor 212-1 may cause display, via the presentation component 220, of each of the ranked candidates-“XT5,” “run,” and “5.” Subsequently, the replacement component 212-3 may receive an indication has selected the “XT5” candidate and responsively cause replacement with “XT5.”

The historical change component 212-4 is generally responsible for tagging the document produced by the document text generator 202 with metadata based on the set of characters being replaced, at the document, with the subset of characters. For example, such metadata can include time stamps indicative of when the replacement component 212-3 caused a replacement of characters, the user identity (ID) of who made the corrections, and/or an annotated document that illustrates the history of changes/replacements made. For instance, original text may be represented by a first color or strikethrough marking, and each subsequent change (for example, replacement) by a specific user of the original text can be marked by different corresponding colors to indicate how many times the original document has been changed and/or by whom.

The presentation component 220 is generally responsible for causing presentation of data to user devices, such as candidates determined by the correct character(s) 212-1 or characters determined to be incorrectly represented by the wrong character(s) detector 208. The presentation component 220 may comprise one or more applications or services on a user device, across multiple user devices, or in the cloud. For example, in one embodiment, presentation component 220 manages the presentation of content to a user across multiple user devices associated with that user. Based on content logic, device features, associated logical hubs, inferred logical location of the user, and/or other user data, presentation component 220 may determine on which user device(s) content is presented, as well as the context of the presentation, such as how (or in what format and how much content, which can be dependent on the user device or context) it is presented and/or when it is presented.

In some embodiments, the presentation component 220 generates (or causes generation of) user interface features. Such features can include interface elements (such as graphics buttons, sliders, menus, audio prompts, alerts, alarms, vibrations, pop-up windows, notification-bar or status-bar items, in-app notifications, or other similar features for interfacing with a user), queries, and prompts.

The consumer application 230 generally refers to a computer application or services, such as online/cloud applications or locally stored applications that consume or utilize the computer objects or computer resources determined by system 200. Examples of consumer applications may include, without limitation, computer applications or services for facilitating meetings or communications; email, messaging, chat, or calling; project management; and/or calendaring or scheduling. For example, suitable consumer applications may include MICROSOFT TEAMS, MICROSOFT DYNAMICS, and/or MICROSOFT OUTLOOK.

Example system 200 also includes storage 225. Storage 225 generally stores information including data, computer instructions (for example, software program instructions, routines, or services), data structures, and/or models used in embodiments of the technologies described herein. By way of example and not limitation, data included in storage 225, as well as any user data, which may be stored in a user profile 240, may generally be referred to throughout as data. Any such data may be sensed or determined from a sensor (referred to herein as sensor data), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other records associated with events; or other activity related information) including user activity that occurs over more than one user device, user history, session logs, application data, contacts data, record data, notification data, social-network data, news (including popular or trending items on search engines or social networks), home-sensor data, appliance data, global positioning system (GPS) data, vehicle signal data, traffic data, weather data (including forecasts), wearable device data, other user device data (which may include device settings, profiles, network connections such as Wi-Fi network data, or configuration data, data regarding the model number, firmware, or equipment, device pairings, such as where a user has a mobile phone paired with a Bluetooth headset, for example), gyroscope data, accelerometer data, other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by a sensor component), data derived based on other data (for example, location data that can be derived from Wi-Fi, Cellular network, or IP address data), and nearly any other source of data that may be sensed or determined as described herein. In some respects, date or information (for example, the requested content) may be provided in user signals. A user signal can be a feed of various data from a corresponding data source. For example, a user signal could be from a smartphone, a home-sensor device, a GPS device (for example, for location coordinates), a vehicle-sensor device, a wearable device, a user device, a gyroscope sensor, an accelerometer sensor, a calendar service, an email account, a credit card account, or other data sources. Some embodiments of storage 225 may have stored thereon computer logic (not shown) comprising the rules, conditions, associations, classification models, and other criteria to execute the functionality of any of the components, modules, analyzers, generators, and/or engines of systems 200.

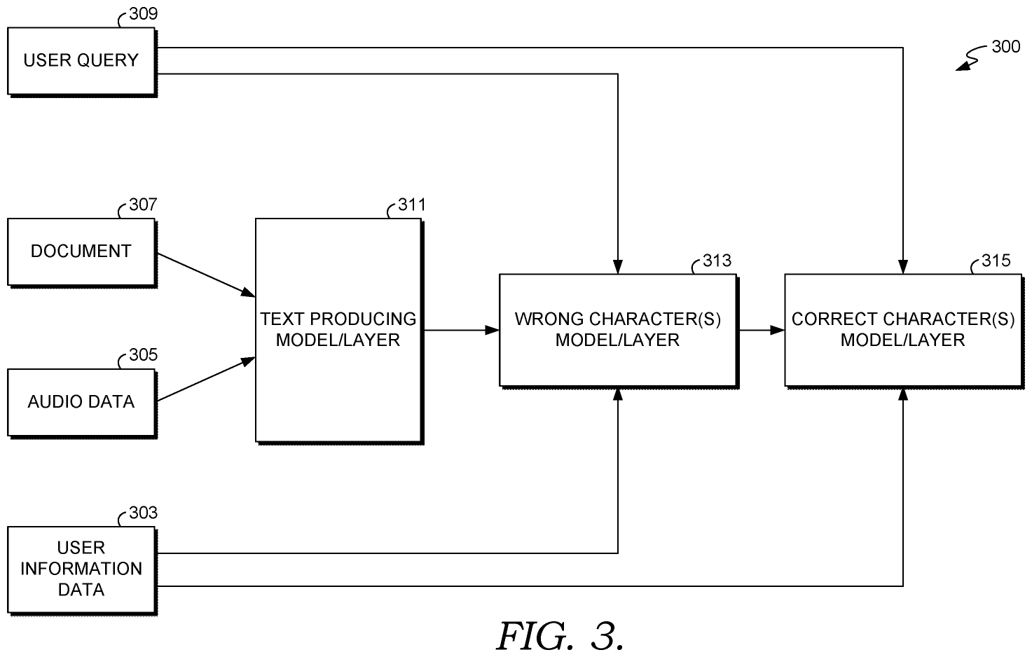

FIG. 3 is a schematic diagram illustrating different models or layers, each of their inputs, and each of their outputs, according to some embodiments. At a first time, the text producing model/layer receives a document 307 and/or the audio data 305. The document 307 may be a raw document or data object, such as an image of a tangible paper or particular file with a particular extension (for example, PNG, JPEG, GIFF). The audio data 305 may be any data that represents sound, where the sound waves from one or more audio signals have been encoded into other forms, such as digital sound or audio. The resulting form can be recorded via any suitable extensions, such as WAV, Audio Interchange File Format (AIFF), MP3, and the like.

At a second time subsequent to the first time, the text producing model/layer 311 converts or encodes the document 307 into a machine-readable document and/or converts or encodes the audio data into a document (both of which may be referred to herein as the “output document”). In some embodiments, the functionality of the text producing model/layer 311 represents or includes the functionality of the document text generator 202. For example, in some embodiments, the text producing model/layer 311 performs OCR on the document 307 (an image) in order to produce a machine-readable document, as described with respect to the document text generator 202. Alternatively or additionally, the text producing model/layer 311 performs speech-to-text functionality to convert the audio data 305 into a transcription document, as described with respect to the document text generator 202.

At a third time, subsequent to the second time, the wrong character(s) model/layer 313 receives, as input, the output document produced by the text producing model/layer 311 (for example, an OCR document or speech-to-text document), a user query 309, and/or user information data 303 in order to determine which character(s) are incorrectly represented in the document produced by the text producing model/layer 311. In some embodiments, the user query 309 is the same query processed by the document query processor 206 of FIG. 2. In some embodiments, the user information data 303 represents the information (for example, information in emails or chats) extracted by the user information extractor 204 of FIG. 2. In some embodiments, the wrong character(s) model/layer 313 represents or includes the functionality as described with respect to the wrong character(s) detector 208 of FIG. 2.

In an illustrative example of the wrong character(s) model/layer 313, this component may determine that the user query 309 does not match and characters at the output document, which is indicative that some characters are incorrectly represented in the document, the wrong character(s) model/layer 313 may additionally perform NSP or MLM on the output document do determine that some sequences are incorrectly ordered. Additionally, the wrong character(s) model/layer 313 may locate the user query 309 in the user information data 303 and determine that similar statements, as found in the output document, are also located in the user information data in order to pinpoint which exact phrases are incorrectly represented in the output document, as described above.

At a fourth time subsequent to the third time, the correct character(s) model/layer 315 takes, as input, the characters predicted to be incorrectly represented via the wrong character(s) model/layer 313, the user information data 303, and/or the user query 309, in order to predict, at the final output, the correct character(s) to replace the incorrectly represented character(s) with. In some embodiments, the correct character(s) model/layer 315 represents or includes the functionality as described with respect to the character replacement suggestion component 212 of FIG. 2.

In an illustrative example of the correct character(s) model/layer 315, given that the wrong character(s) model/layer 313 determines which characters are not correctly represented in the output document, the correct characters model/layer 315 may then determine that the user query 309 itself is a candidate to replace the incorrectly represented words based on similar statements made in the user information data 303.

In some embodiments, “similar statements” may be based on using clustering algorithms where distance measures (for example, Euclidian distance) is determined between characters of the output document and documents or other character sequences of the user information data 303. For example, the wrong character(s) model/layer 313 and/or the correct character(s) model/layer 315 may encode one or more sections (for example, paragraphs or sentences) of the output document into a first feature vector to represents the corresponding characters and may also encode user information from one or more sources (for example, email, chat, historical documents, SMS text) into a second feature vector and responsively determine a distance between the two vectors to determine how similar the characters are. If the distance between the two vectors are within a threshold, this is indicative that the two different vectors represent sources that share very similar statements. This may be indicative of where, in the output document, wrong characters may be and which characters, in the user information data 303, may contain the correct characters. Other algorithms may alternatively or additionally be used, such as a Jaccard Index to determine the overlap (i.e., union) of characters between the output document and one or more sources (for example, emails, chats, documents) of the user information data 303.

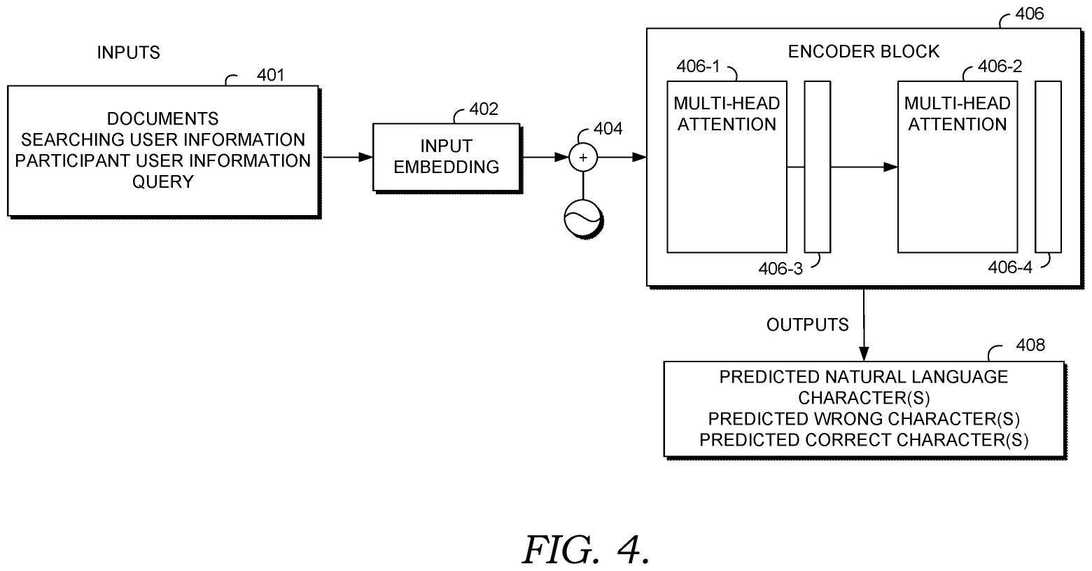

FIG. 4 is a block diagram of a modified BERT model or encoder that uses particular inputs to predict certain natural language characters, whether they are incorrectly represented, and if they are incorrectly represented, what the predicted correct replacements candidates are, according to some embodiments. In some embodiments, this model represents or includes the functionality as described with respect to the wrong character(s) model 313, the correct character(s) model/layer 315 of FIG. 3, the wrong character(s) detector 208, and/or the character replacement suggestion component 212 of FIG. 2.

First, one or more of the inputs 401 are converted into feature vectors and embedded into an input embedding 402 to derive meaning of an individual word (for example, English semantics). In some embodiments, the documents of the inputs 401 include the output document as described with respect to FIG. 3. Alternatively or additionally, the documents include other document to understand English language, such as text books, periodicals, blogs, social media feeds, and the like. In some embodiments, the “searching user information embedding” refers to user information (for example, user information data 303) about a user that issues a query request, which is processed by the document query processor 206. For example, the querying user's emails, chats, meeting transcripts, and the like can all be concatenated into the searching user information embedding. Alternatively or additionally, or additionally the participant user information embedding can be provided as input. The “participant user information embedding” may refer to each user or meeting participant that is invited to or has participated in a meeting associated with a meeting transcript output document. For example, the participant user information embedding may include emails, chats, documents, or texts from each participant that has spoken, as indicated in the output speech-to-text document produced by the text producing model/layer 311. In some embodiments, the “query” is the query executed and processed by the document query processor 206.

In some embodiments, each word or character in the input(s) 401 is mapped into the input embedding 402 in parallel or at the same time, unlike existing LSTM models, for example. The input embedding 402 maps a word to a feature vector representing the word. But the same word (for example, “apple”) in different sentences may have different meanings (for example, phone v. fruit). This is why a positional encoder 404 can be implemented. A positional encoder is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sign/cosine function to generate the positional encoder vector as follows:

PE_{(pos,2i)}=sin(pos/10000^{2i/d}^{_{model}})

PE_{(pos,2i+1)}=cos(pos/10000^{2i/d}^{_{model}})

After passing the input(s) 401 through the input embedding 1002 and applying the positional encoder 404, the output is a word embedding feature vector, which encodes positional information or context based on the positional encoder 404. These word embedding feature vectors are then passed to the encoder block 406, where it goes through a multi-head attention layer 406-1 and a feedforward layer 406-2. The multi-head attention layer 406-1 is generally responsible for focusing or processing certain parts of the feature vectors representing specific portions of the input(s) 401 by generating attention vectors. For example, in Question Answering systems, the multi-head attention layer 406-1 determines how relevant the i^{th} word (or particular word in a block) is for answering the question or relevant to other words in the same or other blocks, the output of which is an attention vector. For every word, some embodiments generate an attention vector, which captures contextual relationships between other words in the same sentence, block, and or line. For a given word, some embodiments compute a weighted average or otherwise aggregate attention vectors of other words that contain the given word (for example, other words in the same line or block) to compute a final attention vector.

In some embodiments, a single headed attention has abstract vectors Q, K, and V that extract different components of a particular word. These are used to compute the attention vectors for every word, using the following formula:

$$Z = softmax ( \frac{Q . {K}^{T}}{\sqrt{Dimension of vector Q , K or V}} ) . V$$

For multi-headed attention, there a multiple weight matrices W^{q}, W^{k} and W^{v}, so there are multiple attention vectors Z for every word. However, a neural network may only expect one attention vector per word. Accordingly, another weighted matrix, W^{z}, is used to make sure the output is still an attention vector per word. In some embodiments, after the layers 406-1 and 406-2, there is some form of normalization (for example, batch normalization and/or layer normalization) performed to smoothen out the loss surface making it easier to optimize while using larger learning rates.

Layers 406-3 and 406-4 represent residual connection and/or normalization layers where normalization re-centers and re-scales or normalizes the data across the feature dimensions. The feed forward layer 406-2 is a feed forward neural network that is applied to every one of the attention vectors outputted by the multi-head attention layer 406-1. The feed forward layer 406-2 transforms the attention vectors into a form that can be processed by the next encoder block or making a prediction at 408. For example, given that a user has currently (or historically via the user information data 303) typed a first natural language sequence “the due date is . . . ” the encoder block 406 can predict that the next natural language sequence (or field type) will be a specific date or be particular words based on past documents that include language identical or similar to the first natural language sequence.

In some embodiments, the encoder block 406 includes pre-training and fine-tuning to learn language (pre-training) and make the predictions at 408 (fine-tuning). In some embodiments, pre-training is performed to understand language and fine-tuning is performed to learn a specific task, such as learning an answer to a set of questions (in QA systems), learning the incorrectly represented characters in a document, and/or learning the correct characters to replace the incorrectly represented characters, as described herein.

In some embodiments, the encoder block 406 learns what language and context for a word is in pre-training by training on two unsupervised tasks—MLM and NSP—simultaneously or at the same time. In terms of the inputs and outputs, at pre-training, the only input of 401 may be various historical documents, such as text books, journals, periodicals (and not user information) in order to output the predicted natural language characters in 1008 (not wrong/correct characters at this point) The encoder block 406 takes in a sentence, paragraph, or line (for example, included in the input(s) 401), with random words being replaced with masks. The goal is to output the value or meaning of the masked tokens. For example, if a line reads, “please [MASK] this document promptly,” the prediction for the “mask” value is “send.” This helps the encoder block 406 understand the bidirectional context in a sentence, paragraph, or line at a document. In the case of NSP, the encoder 406 takes, as input, two or more elements, such as sentences, lines, or paragraphs and determines, for example, if a second line in a document actually follows (for example, is directly below) a first line in the document. This helps the encoder block 406 understand the context across all the elements of a document, not just within a single element. Using both of these together, the encoder block 406 derives a good understanding of natural language.

In some embodiments, during pre-training, the input to the encoder block 406 is a set (for example, 2) of masked sentences (sentences for which there are one or more masks), which could alternatively be partial strings or paragraphs. In some embodiments, each word is represented as a token, and some of the tokens, are masked. Each token is then converted into a word embedding (for example, 402). At the output side is the binary output for the next sentence prediction. For example, this component may output 1, for example, if masked line 2 followed (for example, was directly beneath) masked block 1. The output is word feature vectors that correspond to the outputs for the machine learning model functionality. Thus, the number of word feature vectors that are input is the same number of word feature vectors that are output.

In some embodiments, the initial embedding (for example, the input embedding 402) is constructed from three vectors—the token embeddings, the segment or context-question embeddings, and the position embeddings. In some embodiments, the following functionality occurs in the pre-training phase. The token embeddings are the pre-trained embeddings. The segment embeddings are the sentence number (that includes the input(s) 401) that is encoded into a vector (for example, first sentence, second sentence, etc. assuming a top-down and right-to-left approach). The position embeddings are vectors that represent the position of a particular word in such sentence that can be produced by 404. When these three embeddings are added or concatenated together, an embedding vector is generated that is used as input into the encoder block 406. The segment and position embeddings are used for temporal ordering since all of the vectors are fed into the encoder block 406 simultaneously and language models need some sort of order preserved.

In pre-training, the output is typically a binary value C (for NSP) and various word vectors (for MLM). With training, a loss (for example, cross entropy loss) is minimized. In some embodiments, all the feature vectors are of the same size and are generated simultaneously. As such, each word vector can be passed to a fully connected layered output with the same number of neurons equal to the same number of tokens in the vocabulary.

Some embodiments are additionally responsible for fine tuning the encoder block 406 after it has been pre-trained. In terms of the inputs and output, the input(s) 401 may now include the searching user information embedding, the participant user information embedding, and/or the query and the output 1008 may now include the predicted wrong character(s) and the predicted correct characters. Once pre-training is performed, the encoder block 406 can be trained on very specific tasks, such as Question Answering, modified NSP or MLM, determining characters-wrong/correct character pairs, and the like. In QA tasks, models receive a question regarding text content (for example, “given the sentence X, is it incorrectly represented in a document?”) and mark or tag the beginning and end of the answer (for example, “send John the document”) in a document. For example, in Question Answering, some embodiments replace the fully connected output layers of the encoder block 406 using in pre-training, with a fresh set of output layers that can output the answer to a given question. Subsequently, supervised training can be performed using a Question Answering dataset.

Accordingly certain embodiments can change the model for fine-tuning by changing the input layer and the output layer. That is, for example, the inputs are changed from the masked sentence 1 and 2 tokens to a “question” and “sentence” that contains an answer (or candidate answer) as the tokens. In the output layer, certain embodiments output the start and end words (or characters) that encapsulates the answer. In some embodiments, such question-answer pairs are specifically labeled as completed or not completed (for example, answered or not answered).

In an illustrative example of fine-tuning or making inferences with the encoder block 406, some embodiments learn that given the searching user information, the participant user information, a specific output document, and a query a user has issued, that a specific sentence in the document is incorrectly represented because a similar sentence is indicated in the user information. In this way, a language model can be trained and fine-tuned not only to understand natural language but predict what characters are incorrectly represented in a document and predict replacement candidates based on user information and/or a query that a user has issued. In some embodiments, such predictions can be in near real-time relative to the time at which users input particular characters at document based on processing the input through the language model.

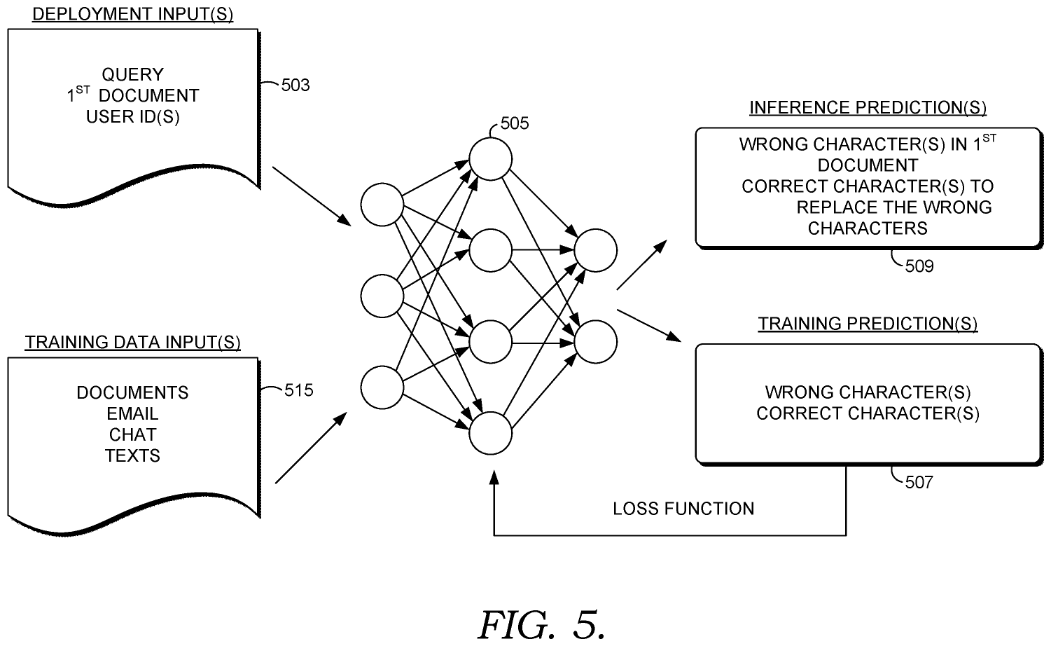

FIG. 5 is a schematic diagram illustrating how a neural network 505 makes particular training and deployment predictions given specific inputs, according to some embodiments. In one or more embodiments, a neural network 505 represents or includes at least some of the functionality as described with respect to the encoder block 406 of FIG. 4, the wrong character(s) model/layer 313, the correct character(s) model/layer 315 of FIG. 3, the wrong character(s) detector 208, and/or the character replacement suggestion component 212 of FIG. 2.

In various embodiments, the neural network 505 is trained using one or more data sets of the training data input(s) 515 in order to make acceptable loss training prediction(s) 507, which will help later at deployment time to make correct inference prediction(s) 509. In one or more embodiments, learning or training can include minimizing a loss function between the target variable (for example, an incorrectly represented set of characters) and the actual predicted variable (for example, a correctly represented set of characters at a first training epoch). Based on the loss determined by a loss function (for example, Mean Squared Error Loss (MSEL), cross-entropy loss, etc.), the loss function learns to reduce the error in prediction over multiple epochs or training sessions so that the neural network 505 learns which features and weights are indicative of the correct inferences, given the inputs. Accordingly, it may be desirable to arrive as close to 100% confidence in a particular classification or inference as possible so as to reduce the prediction error. In an illustrative example, the neural network 505 can learn over several epochs that for a given email, chat thread, query, and/or SMS text, as indicated in the training data input(s) 515, the likely or predicted correct characters (for example, the candidates to replace wrong characters), such as a next sentence in NSP.

Subsequent to a first round/epoch of training (for example, processing the “training data input(s)” 515), the neural network 505 may make predictions, which may or may not be at acceptable loss function levels. For example, the neural network 505 may process a document of the training input(s) 515. Subsequently, the neural network 505 may predict that certain natural language character strings are correctly represented in the document. This process may then be repeated over multiple iterations or epochs until the optimal or correct predicted value(s) is learned (for example, by maximizing rewards and minimizing losses) and/or the loss function reduces the error in prediction to acceptable levels of confidence. For example, using the illustration above, the neural network 505 may learn that the certain natural language character strings are incorrectly represented, instead of correctly represented.

In one or more embodiments, the neural network 505 converts or encodes the runtime input(s) 503 and training data input(s) 515 into corresponding feature vectors in feature space (for example, via a convolutional layer(s)). A “feature vector” (also referred to as a “vector”) as described herein may include one or more real numbers, such as a series of floating values or integers (for example, [0, 1, 0, 0]) that represent one or more other real numbers, a natural language (for example, English) word and/or other character sequence (for example, a symbol (for example, @, !, #), a phrase, and/or sentence, etc.). Such natural language words and/or character sequences correspond to the set of features and are encoded or converted into corresponding feature vectors so that computers can process the corresponding extracted features. For example, embodiments can parse, tokenize, and encode each value for example, a document, template, email messages, or chat) into a one or more feature vectors.

In some embodiments, the neural network 505 learns, via training, parameters, or weights so that similar features are closer (for example, via Euclidian or Cosine distance) to each other in feature space by minimizing a loss via a loss function (for example, Triplet loss or GE2E loss). Such training occurs based on one or more of the training data input(s) 515, which are fed to the neural network 505. For instance, the training data input(s) 515 can correspond to a historical document made by a user, several emails of the user, and various chat messages of the user.

One or more embodiments can determine one or more feature vectors representing the input(s) 515 in vector space by aggregating (for example, mean/median or dot product) the feature vector values to arrive at a particular point in feature space. For example, certain embodiments can formulate a dot product of the documents, templates, emails, and chat messages and then aggregate these values into a single feature vector.

In one or more embodiments, the neural network 505 learns features from the training data input(s) 915 and responsively applies weights to them during training. A “weight” in the context of machine learning may represent the importance or significance of a feature or feature value for prediction. For example, each feature may be associated with an integer or other real number where the higher the real number, the more significant the feature is for its prediction. In one or more embodiments, a weight in a neural network or other machine learning application can represent the strength of a connection between nodes or neurons from one layer (an input) to the next layer (an output). A weight of 0 may mean that the input will not change the output, whereas a weight higher than 0 changes the output. The higher the value of the input or the closer the value is to 1, the more the output will change or increase. Likewise, there can be negative weights. Negative weights may proportionately reduce the value of the output. For instance, the more the value of the input increases, the more the value of the output decreases. Negative weights may contribute to negative scores.

In another illustrative example of training, one or more embodiments learn an embedding of feature vectors based on learning (for example, deep learning) to detect similar features between training data input(s) 515 in feature space using distance measures, such as cosine (or Euclidian) distance. For example, the training data input 515 is converted from string or other form into a vector (for example, a set of real numbers) where each value or set of values represents the individual features (for example, historical documents, emails, or chats) in feature space. Feature space (or vector space) may include a collection of feature vectors that are each oriented or embedded in space based on an aggregate similarity of features of the feature vector. Over various training stages or epochs, certain feature characteristics for each target prediction can be learned or weighted. For example, for a set of documents in the training input(s) 515 created by a user at, the neural network 505 can learn that particular character sequences are consistently associated with or included in particular documents or specific natural language characters. For example, over 90% of the time, when a natural language sequence, “this agreement is between . . . ” is input at a document, then the next character is a “parties” field, which indicates that given this partial string, a “parties” field is always placed next to it. Consequently, this pattern can be weighted (for example, a node connection is strengthened to a value close to 1, whereas other node connections (for example, representing other fields) are weakened to a value closer to 0). In this way, embodiments learn weights corresponding to different features such that similar features found in inputs contribute positively for predictions.

In some embodiments, such training is supervised using annotations or labels. Alternatively or additionally, in some embodiments, such training is not-supervised using annotations or labels but can, for example, include clustering different unknown clusters of data points together. In an illustrative example of supervised learning, each document may be labeled with question-answer (QA) pairs or other pairs (for example, characters-incorrect/correct/replacement pairs) that indicate the ground truth. For example, a sentence “ . . . the parties are located at . . . ” in a document may be labeled as a question and the indicia “enter address” (indicative of an address field) may be labeled as the answer or correct prediction for the sentence. In other words, the documents with these labeled pairs represent the ground truth (for example, the target variable) for predictions in order to derive and assess loss via a loss function. In this way, for example, whenever a document includes the phrase “the parties are located at,” particular embodiments aim to reduce loss such that these embodiments predict that the field that belongs to this sentence (i.e., the one the user will place next to this sentence) is an “address” field based on what the model derives from the ground truth. These pairs are described in more detail below.

In one or more embodiments, subsequent to the neural network 505 training, the machine learning model(s) 905 (for example, in a deployed state) receives one or more of the deployment input(s) 503. When a machine learning model is deployed, it has typically been trained, tested, and packaged so that it can process data it has never processed. Responsively, in one or more embodiments, the deployment input(s) 503 are automatically converted to one or more feature vectors and mapped in the same feature space as vector(s) representing the training data input(s) 515 and/or training predictions). Responsively, one or more embodiments determine a distance (for example, a Euclidian distance) between the one or more feature vectors and other vectors representing the training data input(s) 515 or predictions, which is used to generate one or more of the inference prediction(s) 509.

In an illustrative example, the neural network 505 may receive the query, the first document, and a user ID associated with the user that issued the query. The neural network 505 may concatenate the first document and the query into a feature vector, which represents each feature (for example, word) of the document and query. The neural network 505 may then match the user ID to the user ID stored in a data store to retrieve the appropriate user information data, as indicated in the training data input(s) 515. The neural network may then determine a distance (for example, a Euclidian distance) between the vector representing the runtime input(s) 503 and the training data input(s) 515. Based on the distance being within a threshold distance, particular embodiments determine that there are similar natural language characters, such as sentences, and specifically predict which characters in the first document are incorrectly represented and which natural language characters (for example, as found in a user's email message) are correct characters for replacing the incorrectly represented characters, as described herein.

In certain embodiments, the inference prediction(s) 509 may either be hard (for example, membership of a class is a binary “yes” or “no”) or soft (for example, there is a probability or likelihood attached to the labels). Alternatively or additionally, transfer learning may occur. Transfer learning is the concept of re-utilizing a pre-trained model for a new related problem (for example, a new video encoder, new feedback, etc.).

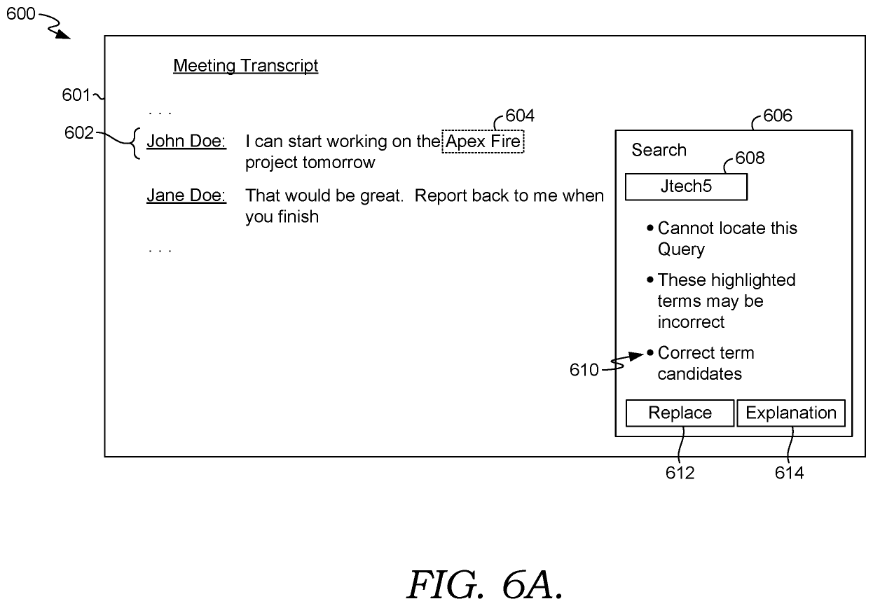

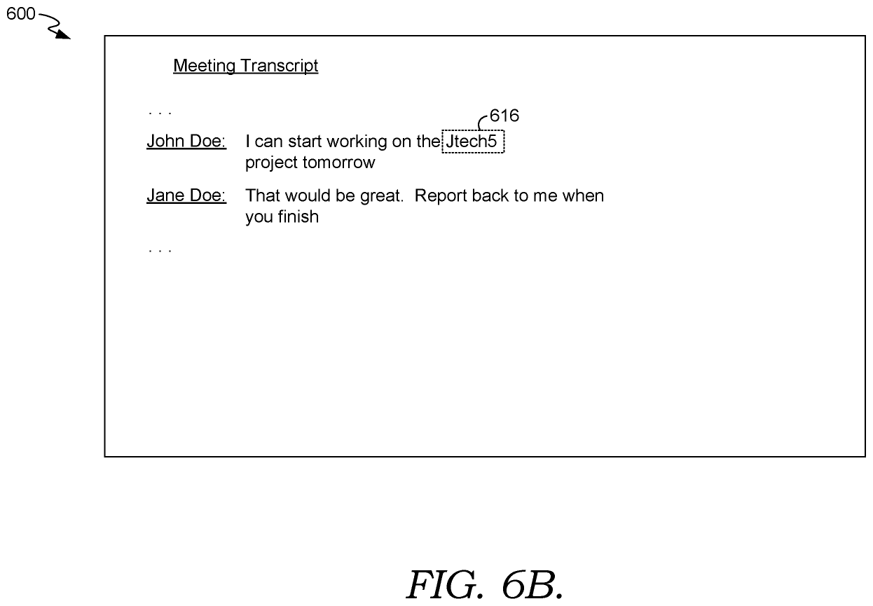

FIG. 6A is a screenshot 600 of an example user interface for replacing characters in a document with other characters, according to some embodiments. In some embodiments, the screenshot 600 represents what is produced or caused to be presented by the presentation component 220 of FIG. 2.

The screenshot 600 includes a meeting transcript document 601, which includes the natural language characters, including the phrase 602 uttered by John Doe and the phrase “Apex fire” 605. In some embodiments, the meeting transcript document 601 is the output produced via speech-to-text functionality. The screenshot 600 further includes the search window 606, which includes the search field 608, a list of the correct term candidates 610, a replace button 612, and an explanation button 614.

At a first time, particular embodiments, such as the document text generator 202 causes the meeting transcript document 601 to be produced. At a second time subsequent to the first time, particular embodiments receive an indication that the user has input the characters “Jtech5” into the search field 608. Responsively, some embodiments determine that the characters “Jtech 5” is not located in the meeting transcript document 601, as described, for example, with respect to the document query processor 206. Responsively, some embodiments, cause presentation of the corresponding indicia “cannot locate this query” to the search window 606, as illustrated in FIG. 6A. Responsively, some embodiments score one or more characters in the document 601 in order to determine or predict that the characters “Apex fire” 604 is incorrectly represented in the document 601. In some embodiments, such determination is performed by the wrong character(s) detector 208, and/or the wrong character(s) model/layer 313, as described herein. Responsive to such determination, particular embodiments cause the phrase “Apex fire” 604 to be highlighted, bolded, or otherwise indicate, at the document 601, that the phrase “Apex fire” is incorrectly represented and cause the indicia “these highlighted terms may be incorrect” to be displayed at the search window 606.

Responsive to such highlighting or otherwise indicating, at the document 601, that the phrase “Apex fire” 604 is incorrectly represented, particular embodiments determine that another set of characters are candidates to replace the “Apex fire” 604 phrase. In some embodiments, such replacement determination is performed via the correct character(s) predictor 212-1 of FIG. 2, and/or the correct character(s) model/layer 315 of FIG. 3, as described herein. Responsive to this determination, some embodiments cause presentation of the correct term candidates 610, which lists each candidate to replace the characters “Apex Fire” 604.

In response to receiving an indication that a user has selected the “explanation” button 604, particular embodiments generate an explanation for why the particular candidates were determined for replacement, as described, for example, with respect to the explanation component 212-2 of FIG. 2. In response to receiving an indication that a user has selected the “replace” button, particular embodiments, such as the replacement component 212-3, cause replacement of the characters “Apex fire” with the characters “Jtech5” 616, as illustrated in FIG. 6B. FIG. 6B is a schematic diagram of a screenshot 600-1 of a user interface, which illustrates the character sequence 604 of FIG. 6A being replaced with the characters 616. As described herein, the characters “Jtech5” 616 may refer to a special project name used by a particular user or business unit. Accordingly, user emails, chats, and the user query “Jtech5” in the field 608, may all indicate that the characters “Jtech5” is top candidate to replace “Apex fire,” as described herein.

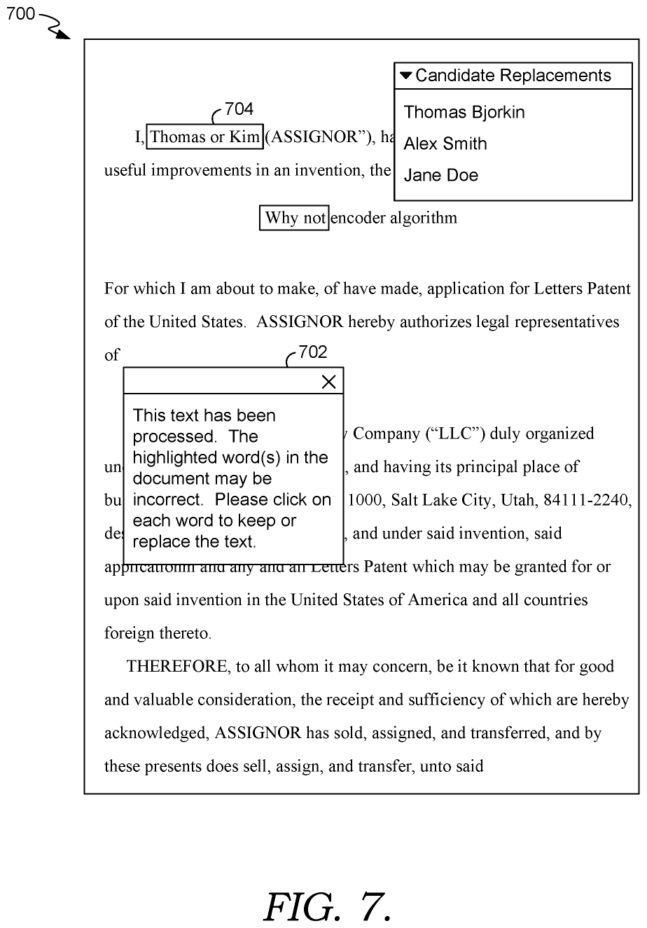

FIG. 7 is a schematic diagram of a document 700 and corresponding user interface functionality for indicating incorrectly represented characters and replacement candidates, according to some embodiments. In some embodiments, the document 700 and corresponding UI elements are caused to be presented by the presentation component 220 of FIG. 2. FIG. 7 illustrates, among other things, that a user need not issue a query request to search for characters at the document 700 in order to determine incorrect representations and replacement candidates, as described herein, such as described with respect to FIG. 6. Rather, some embodiments can analyze an entire document in order to indicate which characters of the document are likely incorrectly represented, as well as candidate replacements without a user query request. In some embodiments, the document 700 represents an output document where OCR or text-to-speech functionality has been performed (for example, as described with respect to the document text generator 202 of FIG. 2).

The document 700 is an Assignment legal document to assign a certain invention to an entity. The document 700 includes the window 702, which indicates that the document 700 has been processed and explain, to a user, that the highlighted indicia represents potential incorrectly represented characters, as well as how to replace such incorrectly represented characters. Specifically, the document 700 includes highlighted indicia 704 (“Thomas or kin”), and 708 (“Why Not Encoder Algorithm”), which indicates that the corresponding characters are incorrectly represented in the document 700. The document 700 further includes the drop-down window 717, which indicates candidate replacements for the highlighted indicia 704.

Some embodiments use the wrong character(s) detector 208 of FIG. 2, and/or the wrong character(s) model/layer 313 of FIG. 3 to detect that the characters 704 and 708 are incorrectly represented in the document 700, as described herein. In some embodiments, in response to receiving an indication that the user has selected the characters 704, particular embodiments cause presentation of the candidate replacement window 706, which list various character sequences (i.e., Thomas Bjorkin, Alex Smith, and Jane Doe) that are candidate characters to replace the character sequence “Thomas or Kin” 704. In some embodiments, the character replacement suggestion component 212 of FIG. 2 and/or the correct character(s) model/layer 315 determines each candidate characters for replacement, as described herein.

As illustrated in the candidate replacement window 716, each set of candidate characters is ranked from top to bottom, with the top set of characters (“Thomas Bjorkin”) being the highest ranked candidate, and the bottom set of characters (“Jane Doe”) being the lowest ranked candidate, as described herein with respect to the replacement component 212-3. In some embodiments, in response to receiving an indication that the user has selected the “Thomas Bjorkin” indicia (or any other candidate) in the candidate replacement window 706, particular embodiments cause the set of characters 704 to be replaced, at the document 700, with the characters “Thomas Bjorkin,” which is a subset of the other character candidates-“Alex Smith,” and “Jane Doe.” Such replacement can occur via functionality as described with respect to the replacement component 212-3 of FIG. 2.

FIG. 8 is a flow diagram of an example process 800 for training a machine learning model using a supervised technique, according to some embodiments. The process 800 (and/or any of the functionality described herein, such as 900) may be performed by processing logic that comprises hardware (for example, circuitry, dedicated logic, programmable logic, microcode, etc.), software (for example, instructions run on a processor to perform hardware simulation), firmware, or a combination thereof. Although particular blocks described in this disclosure are referenced in a particular order at a particular quantity, it is understood that any block may occur substantially parallel with or before or after any other block. Further, more (or fewer) blocks may exist than illustrated. Added blocks may include blocks that embody any functionality described herein (for example, as described with respect to FIG. 1 through FIG. 11). The computer-implemented method, the system (that includes at least one computing device having at least one processor and at least one computer readable storage medium), and/or the computer readable medium as described herein may perform or be caused to perform the process 800 or any other functionality described herein.

In some embodiments, the process 800 is used to train the neural network 505 of FIG. 5, the encoder block 406 of FIG. 4, the wrong character(s) model/layer 313, and/or the correct character(s) mode/layer 315 of FIG. 5.

Per block 802, particular embodiments receive user information data, such as the user information data 303 of FIG. 3 or the user information data obtained by the user information extractor 204. For example, a neural network can receive one or more email messages, chat threads, historic meeting speech-to-text transcripts, or other documents of a user, each of which may contain natural language characters.

Per block 804, some embodiments determine a ground truth and extract one or more features from the user information data. For example, particular embodiments may receive the user information data with labels or annotations indicating whether particular characters are “correctly represented,” “incorrectly represented,” or are “candidate replacement” characters. In an illustrative example, particular embodiments receive meeting transcription documents with various errors, where users have labeled certain characters as “incorrectly represented,” which represents the ground truth of incorrectly represented characters. Additionally, particular embodiments receive email or chat messages where certain extracted character sequences are labeled as “candidate replacements” for the incorrectly represented characters in the meeting transcription documents, which represents the ground truth for the candidate replacements. Responsively, particular embodiments convert or encode such labeled user information data into one or more feature vectors so that the features of the labeled user information data are represented.

Per block 806, some embodiments identify character-correctness pairs and/or character-replacement pairs based on the ground truth derived at block 804. A “character-correctness pair” is a set of characters from the user information data that is paired with either an incorrect label (indicating that the set of characters are incorrectly represented) or a correct label (indicating that the set of characters are correctly represented), only one of which may indicate the ground truth. For example, particular embodiments can pair each word or sentence in several documents, with indications that they are either correctly represented or not correctly represented (which may or may not indicate the ground truth). A “character replacement pair” is a set of characters from the user information data that is paired with either a ground truth replacement candidate (indicating that the replacement candidate is a correct replacement for the set of characters) or a non-replacement (or lower ranked) candidate (indicating that the non-replacement is not a correct replacement for the set of characters). For example, particular embodiments can pair each word or sentence in several meeting transcription documents, with other words or sentences from user emails, chats, and the like that indicate the ground truth replacement candidates or incorrect replacements.

Per block 808, some embodiments train a machine learning model based on learning weights associated with the one or more features. In other words, the machine learning model takes as input, the pairs identified at block 806 and determines patterns associated with each pair to ultimately learn an embedding or the specific features for a given set of characters representing the ground truth. In this way, the model learns which features are present and not present for the given ground truth over multiple iterations or epochs. Training predictions can be continuously made until a loss function is acceptable with respect to the ground truth so that each appropriate node weight or node pathway of a neural network is appropriately activated or not activated, as described with respect to FIG. 5.

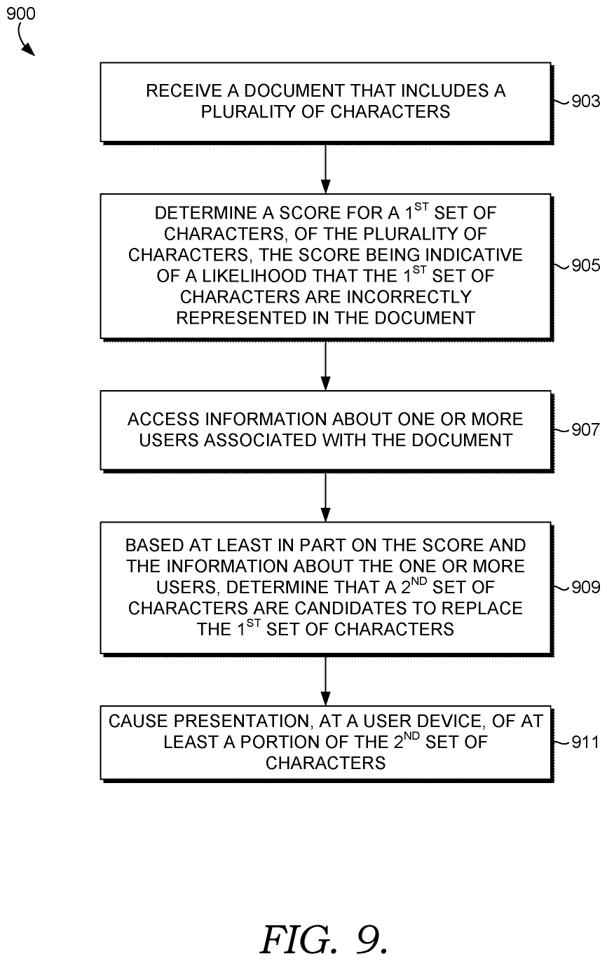

FIG. 9 is a flow diagram of an example process 900 for determining a set of characters that are candidates to replace other characters of a document, according to some embodiments. Per block 903, some embodiments receive a document that includes a plurality of characters. For example, particular embodiments can receive an output document processed via the document text generator 202, as described with respect to FIG. 2. In some embodiments, the document includes a meeting transcript of natural language dialogue between participants associated with a meeting. Such meeting transcript is described, for example, with respect to what the text producing model/layer 311 of FIG. 3 produces using the audio data 305 as feedback. In some embodiments, the plurality of characters include a plurality of letters, one or more numbers, one or more symbols (for example, punctuation symbols, pictures, emojis, etc.), a plurality of words (natural language), and a plurality of sentences.

Some embodiments convert, prior to the receiving of the document at block 903, audio speech data to text data at the document, where the text data includes the plurality of characters, and where the receiving of the document is responsive to the converting. Examples of this are described with respect to the document text generator 202 and the text producing model/layer 311 that takes the audio data 305 as input. Alternatively or additionally, some embodiments convert, prior to the receiving of the document, the document into a computer-readable format via Object Character Recognition (OCR), where the receiving of the document is responsive to the converting. Examples of this are described with respect to the document text generator 202 and the text producing model/layer 311 that takes the document 307 as input.

Per block 905, some embodiments determine a score for a first set of characters, of the plurality of characters, where the score is indicative of a likelihood that the first set of characters are incorrectly represented in the document. In some embodiments, the score is, by implication, additionally indicative of a likelihood that the first set of characters are correctly represented in the document. For example, the score can be a numerical integer on a continuous scale indicating a confidence that a model has in the first set of characters being incorrectly represented, and by implication of the continuous scale, correctly represented. Examples of block 905 are described with respect to the wrong character(s) detector 208 of FIG. 2 and the wrong character(s) model/layer 313 of FIG. 3.

In some embodiments, the determining of the score at block 905 is based on (or includes) predicting, via a machine learning model, that the first set of characters are incorrectly represented in the document based on at least one of: the query request, the information about the one or more users, and natural language processing of the document. Examples of this are described with respect to the wrong character(s) model/layer 313, the encoder 406 of FIG. 4, and the neural network 505 of FIG. 5.

Per block 907, some embodiments access information about one or more users associated with the document. For example, some embodiments access, via a data store, one or more data records (for example, database rows) that include information about the one or more users. For instance, these embodiments can perform a database calling function or query to a database manager component that reads a database to extract and fetch user emails, user chats, user documents and the like of a specific user. In some embodiments, block 907 includes calling a data object that uses a graph data structure, where each node represents different user resources (for example, emails, chats, documents) of a specific user so that all of the information about that specific user can be determined.

In some embodiments, the one or more users includes a user that issues a query request. For example, a user may issue a query request to do a computer search at the document of a certain term, as described with respect to the “Jtech5” term of FIG. 6A, and which is executed by the document query processor 206. In some embodiments, the one or more users includes one or more participants of a meeting (for example, associated with the document). For example, referring back to FIG. 6A, the one or more users can be John Doe, Jane Doe, and every other person in a meeting that spoke as part of the meeting transcript 601.

In some embodiments, the user information is derived from at least one source includes one or more: email messages (natural language) sent or received by the one or more users, chat messages (natural language) sent or received by the one or more users, and meeting transcript documents indicating natural language utterances of the one or more users.

Per block 909, based at least in part on the score and the information about the one or more users, some embodiments determine that a second set of characters are candidates to replace the first set of characters. Examples of this are described with respect to the correct character(s) predictor 212-1 and the correct character(s) model/layer 315 of FIG. 3.

Additionally, in some embodiments, this determination is based at least in part on a query request to do a computer search at the document (for example, the query of “Jtech5”, as described with respect to FIGS. 6A and 6B). Examples of this are described with respect to the character replacement suggestion component 212 of FIG. 2, and the correct character(s) model/layer 315 (that uses the query 309 as input) of FIG. 3. In some embodiments, such query request includes a query character sequence that is not included in the document and the score is based at least in part on the query character sequence not being included in the document. A “query character sequence” can include letters that form a natural language word (such as “meeting”) or set of words, or any character sequence even if it does not form a natural language word. This is described with respect to FIG. 6A. For example, the query character sequence “Jtech5” (or other unique character sequence) is not located in the document 601 and the score can be weighted or further adjusted based on this term not being in the document, since it is assumed that the user knows which characters should be in the document. Accordingly, what the user inputs in the query acts as a ground truth character set in the document and when the character set is not in the document, it is more likely that some characters are not correctly represented in the document. Some embodiments execute the query request based at least in part on the score and the information about the one or more users, where the executing of the query request includes determining that the second set of characters are candidates to replace the first set of characters. Examples of this are described with respect to FIGS. 6A and 6B and the document query processor 206 of FIG. 2.

In some embodiments, the determination that the second set of characters are candidates to replace the first set of characters is based at least in part on training a machine learning model using at least one of: historical email messages, historical chat messages, and historical documents that are labeled with ground truth characters that indicated replacements with other characters. Examples of this are described with respect to the process 800 of FIG. 8 and the neural network 505 of FIG. 5 that processes both the training data input(s) 515 and the deployment input(s) 503 in order to make one or more inference predictions 509. Other examples of this are described with respect to FIG. 4 where the encoder 406 is trained and fin-tuned. In some embodiments, “training” includes fine-tuning.

In some embodiments, the determining that the second set of characters are candidates to replace the first set of characters is based at least in part on a subset (for example, a word or sentence) of the second set of characters matching one or more characters of the query request. For example, referring back to FIG. 6A, because the term “Jtech5” in the user data matches (for example, has the same letter/character sequence) the “Jtech5” query, these characters is a candidate for replacement.

Per block 911, some embodiments cause presentation, at a user device, of at least a portion of the second set of characters. For example, referring back to FIG. 7, the second set of characters may be “Thomas Bjorkin,” “Alex Smith,” and “Jane Doe.” And a “portion” of the second set of characters may be an individual word sequence or name, such as “Thomas Bjorkin.” In some embodiments, block 911 occurs based at least in part on the determining at block 909.

In addition to block 911, some embodiments cause the first set of characters to be replaced, at the document, with a subset of the second set of characters. For example, referring back to FIG. 7, some embodiments cause the characters “Thomas or kin” 704 to be replaced with the characters “Thomas Bjorkin,” which is a subset of the other candidate characters-“Alex Smith,” and “Jane Doe.” In some embodiments, such replacement is based at least in part on user input at a user interface associated with the document, as described, for example, with respect to selecting the correct term candidate 610 or the replacement button 612 of FIG. 6, or “Thomas Bjorkin” in the candidate replacement window 706 of FIG. 7. These FIGs also describe examples where the causing of the replacement is based on receiving an indication that a user has selected, at the user interface, a user interface element associated with the subset, where the user interface element is among a plurality of user interface elements associated with the second set of characters. Alternatively or additionally, the presentation of at least a portion of the second set of characters occurs automatically (for example, without user input) and is included in an operation to replace the first set of characters with the portion of the second set of characters at the document.

Some embodiments additionally cause a tagging of the document with metadata (for example, timestamps of replacement) based on the first set of characters being replaced, at the document, the subset of the second set of characters. Examples of this are described with respect to the historical change component 212-4 of FIG. 2.

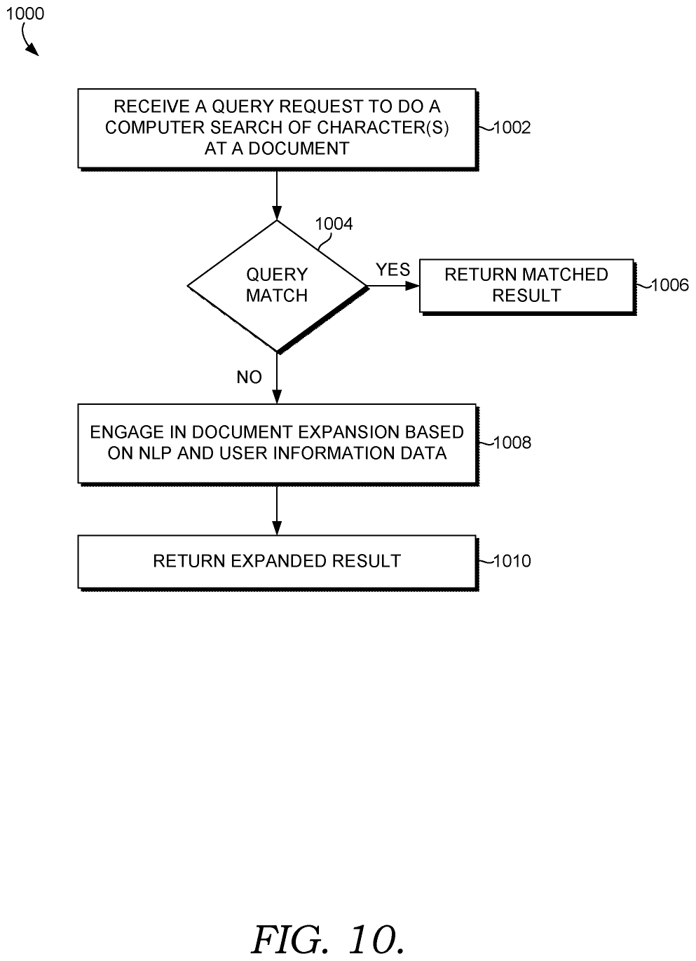

FIG. 10 is a flow diagram of an example process for executing a query request to do a computer search of one or more characters at a document, according to some embodiments. Per block 1002, some embodiments receive a query request to do a computer search of one or more characters at a document (for example, an output document produced by the ted producing model/layer 311). For example, referring back to FIG. 6A, particular embodiments can receive an indication that a user has inputted the query “Jtech5” into the search field 608 and has submitted the query.

Per block 1004, some embodiments determine whether the one or more characters of the query match any other one or more characters in the document. For example, referring back to FIG. 6A, particular embodiments determine whether any words or character sequences match (include the same characters as) “Jtech5.” Per block 1006, if there is a match, then the matched result is returned. For example, referring back to FIG. 6A, if the term “Jtech5” is found in the document 601, then some embodiments automatically move to the place in the document 601 and cause a highlighting (for example, via a particular color) of the term “Jtech5,” for display.

Per block 1008, if there is no query match, particular embodiments engage in document expansion based on NLP and user information data. Examples of document expansion are described with respect to the document query processor 206 of FIG. 2. In an illustrative example, the wrong character(s) detector(s) 208 and/or the character replacement suggestion component 212 may perform NLP (for example, via the encoder 406 of FIG. 4) and determine patterns in the user information data (for example, via the encoder 405 and/or the neural network 506 of FIG. 5) in order to determine candidates to replace characters deemed to be incorrectly represented in the document. Per block 1010, particular embodiments return the expanded result. For example, referring back to FIG. 6B, based on the user selecting the characters “Jtech5” in the correct term candidates UI element 610, some embodiments cause presentation of the characters “Jtech5” 616 at the document 601.

Having described various embodiments of the disclosure, an exemplary computing environment suitable for implementing embodiments of the disclosure is now described. With reference to FIG. 11, an exemplary computing device 1100 is provided and referred to generally as computing device 1100. The computing device 1100 is but one example of a suitable computing environment and is not intended to suggest any limitation as to the scope of use or functionality of the disclosure. Neither should the computing device 1100 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine, such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure may be practiced in a variety of system configurations, including mobile devices, consumer electronics, general-purpose computers, more specialty computing devices, or the like. Embodiments of the disclosure may also be practiced in distributed computing environments where tasks are performed by remote-processing devices that are linked through a communications network. In a distributed computing environment, program modules may be located in both local and remote computer storage media including memory storage devices.

Some embodiments may comprise an end-to-end software-based system that can operate within system components described herein to operate computer hardware to provide system functionality. At a low level, hardware processors may execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. Accordingly, in some embodiments, computer-executable instructions may include any software, including low level software written in machine code, higher level software such as application software and any combination thereof. In this regard, the system components can manage resources and provide services for system functionality. Any other variations and combinations thereof are contemplated with embodiments of the present disclosure.

With reference to FIG. 11, computing device 1100 includes a bus 10 that directly or indirectly couples the following devices: memory 12, one or more processors 14, one or more presentation components 16, one or more input/output (I/O) ports 18, one or more I/O components 20, and an illustrative power supply 22. Bus 10 represents what may be one or more busses (such as an address bus, data bus, or combination thereof). Although the various blocks of FIG. 11 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 11 is merely illustrative of an exemplary computing device that can be used in connection with one or more embodiments of the present disclosure. Distinction is not made between such categories as “workstation,” “server,” “laptop,” “handheld device,” or other computing device, as all are contemplated within the scope of FIG. 11 and with reference to “computing device.”

Computing device 1100 typically includes a variety of computer-readable media. Computer-readable media can be any available media that can be accessed by computing device 1900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 1100. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 12 includes computer storage media in the form of volatile and/or nonvolatile memory. The memory may be removable, non-removable, or a combination thereof. Exemplary hardware devices include solid-state memory, hard drives, optical-disc drives, or other hardware. Computing device 1100 includes one or more processors 14 that read data from various entities such as memory 12 or I/O components 20. Presentation component(s) 16 presents data indications to a user or other device. Exemplary presentation components include a display device, speaker, printing component, vibrating component, and the like.

The I/O ports 18 allow computing device 1100 to be logically coupled to other devices, including I/O components 20, some of which may be built in. Illustrative components include a microphone, joystick, game pad, satellite dish, scanner, printer, wireless device, and the like. The I/O components 20 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1900. The computing device 1100 may be equipped with depth cameras, such as stereoscopic camera systems, infrared camera systems, RGB camera systems, and combinations of these, for gesture detection and recognition. Additionally, the computing device 1100 may be equipped with accelerometers or gyroscopes that enable detection of motion. The output of the accelerometers or gyroscopes may be provided to the display of the computing device 1100 to render immersive augmented reality or virtual reality.

Some embodiments of computing device 1100 may include one or more radio(s) 24 (or similar wireless communication components). The radio 24 transmits and receives radio or wireless communications. The computing device 1100 may be a wireless terminal adapted to receive communications and media over various wireless networks. Computing device 1100 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. Generally, “short” and “long” types of connections do not refer to a spatial relation between two devices. Rather, these terms refer generally to short range and long range as categories, or types, of connections (for instance, a primary connection and a secondary connection). A short-range connection may include, by way of example and not limitation, a Wi-Fi® connection to a device (for example, mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions, and the like.) can be used in addition to or instead of those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

As used herein, the term “set” may be employed to refer to an ordered (i.e., sequential) or an unordered (i.e., non-sequential) collection of objects (or elements), such as but not limited to data elements (for example, events, clusters of events, and the like). A set may include N elements, where N is any non-negative integer. That is, a set may include 0, 1, 2, 3, . . . N objects and/or elements, where N is an positive integer with no upper bound. Therefore, as used herein, a set may be a null set (i.e., an empty set), that includes no elements. A set may include only a single element. In other embodiments, a set may include a number of elements that is significantly greater than one, two, or three elements. As used herein, the term “subset,” is a set that is included in another set. A subset may be, but is not required to be, a proper or strict subset of the other set that the subset is included in. That is, if set B is a subset of set A, then in some embodiments, set B is a proper or strict subset of set A. In other embodiments, set B is a subset of set A, but not a proper or a strict subset of set A.

### OTHER EMBODIMENTS

In some embodiments, a computerized system, such as the computerized system described in any of the embodiments above, comprise at least one computer processor, one or more computer storage media storing computer-useable instructions that, when used by the at least one computer processor, cause the at least one computer processor to perform operations. The operations comprise receiving a document that includes a plurality of characters. The operations further comprising determining a score for a first set of characters, of the plurality of characters, where the score is indicative of a likelihood that the first set of characters are incorrectly represented in the document. The operations further comprising accessing, via a data store, one or more data records that include information about one or more users associated with the document. The operations further comprising receiving a query request to do a computer search at the document. The operations further comprising based at least in part on: the score, the information about the one or more users, and the query request, determining that a second set of characters are candidates to replace the first set of characters. The operations further comprising based at least in part on user input at a user interface associated with the document, causing the first set of characters to be replaced, at the document, with at least a subset of the second set of characters. Advantageously, these and other embodiments, as described herein, provide several technical solutions to technical problems described herein, such as improving the accuracy of existing speech-to-text technologies, improving speech-to-text technologies even when there are phonetic issues, such as unique accents or unique words/phrases spoken, improving speech-to-text technologies even when there are network hikes or outages, improving existing machine learning models, improving the accuracy of existing Optical Character Recognition (OCR) technologies, and improving the way computers operate, such as improvement in the retrieval of data.

In any combination of the above embodiments of the computerized system, the document includes a meeting transcript of natural language dialogue between participants associated with a meeting, and wherein the plurality of characters include at least one of: a plurality of letters, one or more numbers, one or more symbols, a plurality of words, and a plurality of sentences.

In any combination of the above embodiments of the computerized system, the determining of the score is based on predicting, via a machine learning model, that the first set of characters are incorrectly represented in the document based on at least one of: the query request, the information about the one or more users, and natural language processing of the document.

In any combination of the above embodiments of the computerized system, the information about the one or more users is derived from at least one source associated with a user that issues the query request, the at least one source includes one or more of: email messages sent or received by the user, chat messages sent or received by the user, and meeting transcript documents indicating natural language utterances of the user.

In any combination of the above embodiments of the computerized system, the information about the one or more users is derived from at least one source associated with each participant of a meeting, the at least one source includes one or more of: email messages sent or received by each participant, chat messages sent or received by each participant, and meeting transcript documents indicating natural language utterances of each participant.

In any combination of the above embodiments of the computerized system, the query request includes at least one query character sequence that is not included in the document, and wherein the score is based at least in part on the at least one query character sequence not being included in the document.

In any combination of the above embodiments of the computerized system, the determining that the second set of characters are candidates to replace the first set of characters is based at least in part on utilizing a machine learning model that is trained using at least one of: historical email messages, historical chat messages, and historical documents, that each of which are labeled with ground truth characters that indicate replacements for other characters.

In any combination of the above embodiments of the computerized system, the determining that the second set of characters are candidates to replace the first set of characters is based at least in part on the subset of the second set of characters matching one or more characters of the query request.

In any combination of the above embodiments of the computerized system, the causing of the first set of characters to be replaced is based on receiving an indication that a user has selected, at the user interface, a user interface element associated with the subset, the user interface element being among a plurality of user interface elements associated with the second set of characters.

In any combination of the above embodiments of the computerized system, the operations further comprising converting, prior to the receiving of the document, audio speech data to text data at the document, the text data includes the plurality of characters, wherein the receiving of the document is responsive to the converting.

In any combination of the above embodiments of the computerized system, the operations further comprising converting, prior to the receiving of the document, the document into a computer-readable format via object character recognition, wherein the receiving of the document is responsive to the converting.

In any combination of the above embodiments of the computerized system, the operations further comprising causing a tagging of the document with metadata based on the first set of characters being replaced, at the document, with the subset of the second set of characters.

In some embodiments, a computer-implemented method is provided. The computer-implemented method includes receiving a document that includes a plurality of characters. The computer-implemented method further includes determining a score for a first set of characters, of the plurality of characters, the score being indicative of a likelihood that the first set of characters are incorrectly represented in the document. The computer-implemented method further includes accessing information about one or more users associated with the document. The computer-implemented method further includes based at least in part on the score and the information about the one or more users, determining that a second set of characters are candidates to replace the first set of characters. The computer-implemented method further includes based at least in part on the determining that the second set of characters are candidates to replace the first set of characters, causing presentation, at a user device, of at least a portion of the second set of characters. Advantageously, these and other embodiments, as described herein, provide several technical solutions to technical problems described herein, such as improving the accuracy of existing speech-to-text technologies, improving speech-to-text technologies even when there are phonetic issues, such as unique accents or unique words/phrases spoken, improving speech-to-text technologies even when there are network hikes or outages, improving existing machine learning models, improving the accuracy of existing Optical Character Recognition (OCR) technologies, and improving the way computers operate, such as improvement in the retrieval of data.

In any combination of the above embodiments of the computer-implemented method, the computer-implemented method further comprising: receiving a query request to do a computer search, at the document, for one or more characters; and executing the query request based at least in part on the score and the information about the one or more users, and wherein the executing of the query request includes determining that the second set of characters are candidates to replace the first set of characters.

In any combination of the above embodiments of the computer-implemented method, the document includes a meeting transcript of natural language dialogue between participants associated with a meeting, and wherein the plurality of characters include at least one of: a plurality of letters, one or more symbols, a plurality of words, and a plurality of sentences.

In any combination of the above embodiments of the computer-implemented method, the determining of the score is based on predicting, via a machine learning model, that the first set of characters are incorrectly represented in the document based at least in part on the information about the one or more users and natural language processing of the document.

In any combination of the above embodiments of the computer-implemented method, the information about the one or more users is derived from at least one source associated with a participant of a meeting, the at least one source includes one or more of: email messages sent or received by the participant, chat messages sent or received by each participant, and meeting transcript documents that indicate natural language utterances of the participant.

In any combination of the above embodiments of the computer-implemented method, the determining that the second set of characters are candidates to replace the first set of characters is based at least in part on training a machine learning model using at least one of: historical email messages, historical chat messages, and historical documents that are each labeled with ground truth characters that indicate replacements for other characters.

In any combination of the above embodiments of the computer-implemented method, the presentation of at least the portion of the second set of characters occurs automatically and is included in an operation to replace the first set of characters with the portion of the second set of characters at the document or the presentation of at least the portion of the second set of characters is indicative of presenting, to a user device, candidates for a user of the user device to select for replacing the first set of characters with the portion of the second set of characters.

In some embodiments, one or more computer storage media is provided. The one or more computer storage media having computer-executable instructions embodied thereon that, when executed by one or more processors, cause the one or more processors to perform operations comprising receiving a document that includes a plurality of characters. The operations further comprising based at least in part on a score and information about one or more users, determining that a second set of characters are candidates to replace a first set of characters at the document, the first set of characters being among the plurality of characters, the score being indicative of a likelihood that the first set of characters are incorrectly represented in the document. The operations further comprising based at least in part on the determining that the second set of characters are candidates to replace the first set of characters, causing presentation of at least a portion of the second set of characters. Advantageously, these and other embodiments, as described herein, provide several technical solutions to technical problems described herein, such as improving the accuracy of existing speech-to-text technologies, improving speech-to-text technologies even when there are phonetic issues, such as unique accents or unique words/phrases spoken, improving speech-to-text technologies even when there are network hikes or outages, improving existing machine learning models, improving the accuracy of existing Optical Character Recognition (OCR) technologies, and improving the way computers operate, such as improvement in the retrieval of data.

1. A system comprising:
at least one computer processor; and
one or more computer storage media storing computer-useable instructions that, when used by the at least one computer processor, cause the at least one computer processor to perform operations comprising:
receiving a document that includes a plurality of characters;
determining a score for a first set of characters, of the plurality of characters, the score being indicative of a likelihood that the first set of characters are incorrectly represented in the document;
accessing, via a data store, one or more data records that include information about one or more users associated with the document;
receiving a query request to do a computer search at the document;
based at least in part on: the score, the information about the one or more users, and the query request, determining that a second set of characters are candidates to replace the first set of characters; and
based at least in part on user input at a user interface associated with the document, causing the first set of characters to be replaced, at the document, with at least a subset of the second set of characters.

2. The system of claim 1, wherein the document includes a meeting transcript of natural language dialogue between participants associated with a meeting, and wherein the plurality of characters include at least one of: a plurality of letters, one or more numbers, one or more symbols, a plurality of words, and a plurality of sentences.

3. The system of claim 1, wherein the determining of the score is based on predicting, via a machine learning model, that the first set of characters are incorrectly represented in the document based on at least one of: the query request, the information about the one or more users, and natural language processing of the document.

4. The system of claim 1, wherein the information about the one or more users is derived from at least one source associated with a user that issues the query request, the at least one source includes one or more of: email messages sent or received by the user, chat messages sent or received by the user, and meeting transcript documents indicating natural language utterances of the user.

5. The system of claim 1, wherein the information about the one or more users is derived from at least one source associated with each participant of a meeting, the at least one source includes one or more of: email messages sent or received by each participant, chat messages sent or received by each participant, and meeting transcript documents indicating natural language utterances of each participant.

6. The system of claim 1, wherein the query request includes at least one query character sequence that is not included in the document, and wherein the score is based at least in part on the at least one query character sequence not being included in the document.

7. The system of claim 1, wherein the determining that the second set of characters are candidates to replace the first set of characters is based at least in part on utilizing a machine learning model that is trained using at least one of: historical email messages, historical chat messages, and historical documents, that each of which are labeled with ground truth characters that indicate replacements for other characters.

8. The system of claim 1, wherein the determining that the second set of characters are candidates to replace the first set of characters is based at least in part on the subset of the second set of characters matching one or more characters of the query request.

9. The system of claim 1, wherein the causing of the first set of characters to be replaced is based on receiving an indication that a user has selected, at the user interface, a user interface element associated with the subset, the user interface element being among a plurality of user interface elements associated with the second set of characters.

10. The system of claim 1, wherein the operations further comprising converting, prior to the receiving of the document, audio speech data to text data at the document, the text data includes the plurality of characters, wherein the receiving of the document is responsive to the converting.

11. The system of claim 1, wherein the operations further comprising converting, prior to the receiving of the document, the document into a computer-readable format via optical character recognition, wherein the receiving of the document is responsive to the converting.

12. The system of claim 1, wherein the operations further comprising causing a tagging of the document with metadata based on the first set of characters being replaced, at the document, with the subset of the second set of characters.

13. A computer-implemented method comprising:
receiving a document that includes a plurality of characters;
determining a score for a first set of characters, of the plurality of characters, the score being indicative of a likelihood that the first set of characters are incorrectly represented in the document;
receiving a query request to do a computer search of the document:
determining there is not a keyword match between the query and the document:
based at least in part on the score, determining that a keyword from the query is a candidate to replace the first set of characters; and
based at least in part on the determining that the keyword from the query is a candidate to replace the first set of characters, causing presentation, at a user device, of the keyword as a replacement for a portion of the first set of characters.

14. The computer-implemented method of claim 13, further comprising:

15. The computer-implemented method of claim 13, wherein the document includes a meeting transcript of natural language dialogue between participants associated with a meeting, and wherein the plurality of characters include at least one of: a plurality of letters, one or more symbols, a plurality of words, and a plurality of sentences.

16. The computer-implemented method of claim 13, wherein the determining of the score is based on predicting, via a machine learning model, that the first set of characters are incorrectly represented in the document based at least in part on the information about the one or more users and natural language processing of the document.

17. The computer-implemented method of claim 13, wherein the information about the one or more users is derived from at least one source associated with a participant of a meeting, the at least one source includes one or more of: email messages sent or received by the participant, chat messages sent or received by each participant, and meeting transcript documents that indicate natural language utterances of the participant.

18. The computer-implemented method of claim 13, wherein the determining that the keyword from the query is a candidate to replace the first set of characters is based at least in part on training a machine learning model using at least one of: historical email messages, historical chat messages, and historical documents that are each labeled with ground truth characters that indicate replacements for other characters.

19. The computer-implemented method of claim 13, wherein the presentation of at least the portion of the second set of characters occurs automatically and is included in an operation to replace the first set of characters with the portion of the second set of characters at the document or the presentation of at least the portion of the second set of characters is indicative of presenting, to a user device, candidates for a user of the user device to select for replacing the first set of characters with the portion of the second set of characters.

20. One or more computer storage media having computer-executable instructions embodied thereon that, when executed, by one or more processors, cause the one or more processors to perform operations comprising:
receiving a document that includes a plurality of characters;
based at least in part on a score and a query of the document, determining that a second set of characters from the query are candidates to replace a first set of characters at the document, the first set of characters being among the plurality of characters, the score being indicative of a likelihood that the first set of characters are incorrectly represented in the document; and
based at least in part on the determining that the second set of characters are candidates to replace the first set of characters, causing presentation of at least a portion of the second set of characters.
